(19) United States
(12) Patent Application Publication
(10) Pub. No.: US 2026/0174626 A1
(43) Pub. Date: Jun. 25, 2026

(54) SYSTEMS AND METHODS FOR A HANDHELD NON-VIBRATORY TACTILE-STIMULATION DEVICE WITH INTERCHANGEABLE FILAMENT HEADS

(71) Applicant: Gordon Dickson, Lacey, WA (US)

(72) Inventor: Gordon Dickson, Lacey, WA (US)

(21) Appl. No.: 19/414,274

(22) Filed: Dec. 10, 2025

Related U.S. Application Data
(60) Provisional application No. 63/735,981, filed on Dec. 19, 2024.

(51) Int. Cl. A61H 23/02

(52) U.S. Cl. CPC A61H 23/0245; A61H 23/0236; A46B 2200/102; A61H 2201/0153; A61H 2201/10; A61H 2201/105; A61H 2201/1215; A61H 2201/1463; A61H 2201/1685; A61H 2201/5005; A61H 2201/5012; A61H 2201/5058; A61H 2201/5082

(57) ABSTRACT

Systems and techniques may generally be used for handheld tactile stimulation using low-speed rotational stroking. A system may include a housing, a power source disposed within the housing, a rotational drive configured to rotate a head coupler, and a removable, interchangeable head attachable to the head coupler. A sensor may be configured to produce a rotational-speed signal, and a controller may regulate the rotational drive based on the rotational-speed signal to maintain a commanded low rotational speed during skin contact. In some aspects, the approach may provide non-vibratory, slow-rotational operation suitable for gentle stroking with interchangeable filament heads. The disclosed arrangements may support feedback-based speed regulation for consistent tactile output, while permitting hygienic head swaps and serviceability without requiring external control during use.

### REFERENCE TO RELATED APPLICATIONS

This application claims priority from U.S. provisional application Ser. No. 63/735,981 filed Dec. 19, 2024, which is incorporated by reference.

### BACKGROUND OF THE INVENTION

### Technical Field

The present disclosure generally relates to handheld haptic and tactile-stimulation systems, and more particularly to devices configured for gentle, low-intensity skin-contact stroking using interchangeable contact elements and electronically controlled rotational actuation in wellness, sensory, and relaxation contexts.

### Description of the Related Art

Handheld consumer massagers and therapeutic devices are known, including vibration, percussive, and ultrasonic/acoustic-pressure systems with replaceable attachments, variable intensity settings, and rechargeable power supplies. Such devices have been reported to produce higher-frequency energy that may be perceived as noisy, may cause user fatigue during extended use, and may exhibit speed or intensity variation under changing contact loads when open-loop controls are employed. Detachable accessories used in shared environments may raise sanitation and wear concerns where cleaning workflows and attachment retention forces vary across units. Some platforms emphasize app-based control, light output, or medicament delivery, which may introduce complexity for basic tactile routines. Prior art in the field may describe massage device architectures with multiple operating modes and accessory interfaces; these approaches illustrate known design patterns for powered handheld stimulation tools and interchangeable heads without addressing the above-noted practical limitations in a uniform manner.

### SUMMARY OF THE INVENTION

Embodiments of the invention may include one or more of the following features. These features may be used singly, or in combination with each other.

In general, in a first aspect, the technologies described herein relate to a handheld tactile-stimulation system that may include a housing, a power source disposed within the housing, a rotational drive configured to rotate a head coupler, a removable, interchangeable head attachable to the head coupler, a sensor configured to produce a rotational-speed signal, and a controller configured to regulate the rotational drive based on the rotational-speed signal to maintain a commanded low rotational speed.

In general, in a second aspect, the technologies described herein relate to the system optionally including a magnetic quick-connect interface, which may include a permanent-magnet element and a ferromagnetic counterface, and may further include a keyed anti-rotation feature that may constrain relative angular misalignment between the interchangeable head and the head coupler.

In general, in a third aspect, the technologies described herein relate to a controller that may execute a closed-loop control algorithm to maintain a commanded rotational speed within plus or minus 5 percent of a setpoint under a 20-gram filament-tip load in a band of 30 to 100 revolutions per minute; and a non-vibratory slow-rotational stroking profile that may omit ultrasonic actuation, acoustic-pressure vibration, optical stimulation, and medicament delivery.

Embodiments of the invention may include one or more of the following features. These features may be used singly, or in combination with each other. A controller may generate a pulse-width modulation (PWM) drive signal at a carrier frequency above 20 kilohertz; an interchangeable head may include a ferrule retaining filament sub-bundles and a proximal stiffness-tuning structure; flexible filaments may include medical-grade silicone within Shore 00-20 to A-10, nylon 6/12, or feather-analog microfibers, configured to be washable and replaceable for gentle skin contact; presets may include lull, drift, and coast trajectories; a session auto-off and a child-lock state may be enforced; a housing may be sized for single-hand grasp and provide at least IPX4 splash resistance, and the head may be detachable for washing; a temperature sensor may provide a signal for speed derating or drive disable above a threshold; a push-rotary knob may provide ON/OFF and continuous speed selection with tactile detents that do not impart vibration; a non-volatile memory may store calibration parameters (including a mapping between motor current and inferred contact force, a commanded-speed-to-PWM-duty lookup adjusted for a speed-reduction train, and a magnet pull-force acceptance range), and the controller may reduce PWM duty cycle when an inferred contact-force threshold is exceeded to maintain gentle contact; and the rotational drive and interchangeable head may be dynamically balanced to a runout limit at the head coupler of less than or equal to 0.25 millimeters during operation within the commanded speed band.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

Aspects described below include a non-transitory computer-readable storage medium comprising computer-executable instructions that, responsive to execution by a processor, cause a system to perform any one of the described methods.

Aspects described below also include a System and Method for A Handheld Non-Vibratory Tactile-Stimulation Device With Interchangeable Filament Heads.

### BRIEF DESCRIPTION OF THE FIGURES

The appended figures depict certain features of the various aspects described herein and are not to be considered limiting of the scope of this disclosure.

FIG. 1 depicts a block diagram of a data processing environment in which illustrative embodiments may be implemented.

FIG. 2 depicts a block diagram of a data processing system in which illustrative embodiments may be implemented.

FIG. 3 depicts internal device internals including housing, power source, rotational drive, controller, memory, and service port, as shown in some embodiments.

FIG. 4 depicts external housing with user control, head coupler nose, installed interchangeable head, and ergonomic grip, as shown in some embodiments.

FIG. 5 depicts interchangeable head detail including ferrule, filament sub-bundles, proximal stiffness-tuning structure, and shoulder seat, as shown in some embodiments.

FIG. 6 depicts alternate removable end-effector head with ferrule coupler, hemispherical filament bundle, and stiffness indicator, as shown in some embodiments.

FIG. 7 depicts electrical and control schematic including controller, sensors, PWM driver, presets logic, and power management, as shown in some embodiments.

FIG. 8 depicts magnetic quick-connect coupling with interface, ferromagnetic counterface, keyed anti-rotation, standoff boss, and wear plate, as shown in some embodiments

FIG. 9 depicts exterior housing perspective showing charging/service connector placement and sealing gasket for ingress protection, as shown in some embodiments.

FIG. 10 depicts in-operation view illustrating rotational stroking envelope and coupler alignment shoulder during gentle use, as shown in some embodiments.

FIG. 11 depicts provisioning and calibration environment including fixture, load rig, tachometer, programming station, and QC record, as shown in some embodiments.

FIG. 12 is a flowchart of an example method for serving/manufacturing/hosting.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known structures, functions, methods, procedures, components, and/or circuitry have been described at a relatively high level, without detail, to avoid unnecessarily obscuring aspects of the present teachings.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list. When the word “each” is used to refer to an element that was previously introduced as being at least one in number, the word “each” does not necessarily imply a plurality of the elements, but can also mean a singular element.

Systems and techniques described herein may be used to overcome the limitations of traditional methods for providing gentle tactile stimulation intended to calm users and support relaxation or pre-sleep routines. Conventional handheld devices that rely on vibration, percussion, or ultrasonic actuation may produce higher-frequency energy that can be perceived as noisy or fatiguing over time, and such devices may not maintain a consistent low-speed stroking behavior when light contact with skin varies during self-use. Devices that lack interchangeable end-effectors may constrain hygiene workflows or limit the range of tactile profiles available to different users and body regions. Prior approaches without feedback control may drift in speed under load, leading to inconsistent sensations from minute to minute, which may complicate repeatable routines for sensitive users in wellness or sensory environments. Packaging and sanitation practices may be uneven when contact elements cannot be detached for cleaning, and head replacement may be impractical where multiple users share a device in institutional settings.

To address these issues, the present disclosure provides a handheld tactile-stimulation system and associated methods that may generate a non-vibratory, slow-rotational stroking profile using an interchangeable filament head and a feedback-regulated rotational drive. The system may include a housing with a power source disposed within the housing, a rotational drive configured to rotate a head coupler, and a removable, interchangeable head attachable to the head coupler. A sensor may be configured to produce a rotational-speed signal, and a controller may regulate the rotational drive based on the rotational-speed signal to maintain a commanded low rotational speed under light contact load. Optional features may include a magnetic quick-connect interface with keyed anti-rotation, a ferrule that may retain filament sub-bundles with a proximal stiffness-tuning structure, presets that may define speed trajectories, a session auto-off and child-lock, and sanitation tracking parameters stored in non-volatile memory. In some aspects, a provisioning process may calibrate speed-to-duty relationships and current-to-force mappings, and a computer-readable medium may store firmware instructions to implement closed-loop control at an inaudible pulse-width modulation carrier frequency.

An example technique may include providing a handheld tactile-stimulation system that may incorporate a housing, a power source disposed within the housing, and a rotational drive that may rotate a head coupler at low rotational speed suitable for gentle stroking. A removable, interchangeable head may be attachable to the head coupler and may present flexible filaments for skin contact. A sensor may produce a rotational-speed signal during operation. A controller may receive the rotational-speed signal and may regulate the rotational drive to maintain a commanded low rotational speed even when contact forces vary, thereby supporting a non-vibratory slow-rotational stroking profile. Optional embodiments may include a magnetic quick-connect interface with a permanent-magnet element and a ferromagnetic counterface, presets that may specify time-varying speed trajectories, and storage in non-volatile memory of calibration parameters that may map commanded speed to duty cycle and motor current to inferred contact force.

Consider a community sensory room that may support de-escalation for adolescents experiencing heightened stress after school. A staff member may select a handheld tactile-stimulation system from a clean storage drawer and attach an interchangeable head pre-labeled for scalp use. The device may power on into a child-lock state, and the staff member may perform the required input sequence, then choose a gentle preset that may target a narrow band of low rotational speed. The adolescent may be seated in a quiet space, and the staff member may guide self-application by demonstrating how the flexible filaments may lightly skim the hairline and neck. As the user varies contact, the sensor may provide a rotational-speed signal, and the controller may regulate the rotational drive to maintain the commanded low rotational speed so that the stroking sensation may remain consistent across passes. After several minutes, the session auto-off may end the routine. The head may be detached and placed in a wash bin, and the system may increment a sanitation counter. For a subsequent session, a different head with longer filaments may be attached for back use; the keyed anti-rotation feature may align the coupler, and the staff member may select a preset that may use a slightly different speed trajectory. The predictable slow-rotational behavior may help the user anticipate the tactile pattern, while the removable head may support hygiene practices between sessions. The same workflow may be adapted for a palliative care clinic where a caregiver may guide a patient through a brief pre-sleep routine, using a preset that may gradually decrease speed and relying on feedback regulation to keep the experience steady despite changes in contact as the patient relaxes.

The illustrative embodiments are described with respect to certain types of machines. The illustrative embodiments are also described with respect to other scenes, subjects, measurements, devices, data processing systems, environments, components, and applications only as examples. Any specific manifestations of these and other similar artifacts are not intended to be limiting to the disclosure. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the disclosure, either locally at a data processing system or over a data network, within the scope of the disclosure. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific surveys, code, hardware, algorithms, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable devices, structures, systems, applications, or architectures therefor, may be used in conjunction with such embodiment of the disclosure within the scope of the disclosure. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

As noted, existing handheld tactile devices are inefficient as they rely on vibration or percussion, exhibit inconsistent low-speed behavior under varying contact loads, complicate hygiene when contact elements are not readily swappable, and introduce complexity through peripheral features unrelated to gentle stroking. To address the challenges associated with traditional methods of delivering consistent, gentle tactile stimulation in shared and personal settings, techniques are described that implement Systems and Methods for Handheld Non-Vibratory Tactile-Stimulation With Interchangeable Filament Heads.

The illustrative embodiments are described with respect to certain types of machines. The illustrative embodiments are also described with respect to other scenes, subjects, measurements, devices, data processing systems, environments, components, and applications only as examples. Any specific manifestations of these and other similar artifacts are not intended to be limiting to the disclosure. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the disclosure, either locally at a data processing system or over a data network, within the scope of the disclosure. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific surveys, code, hardware, algorithms, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable devices, structures, systems, applications, or architectures therefor, may be used in conjunction with such embodiment of the disclosure within the scope of the disclosure. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various processes described herein may be implemented by appropriately programmed general purpose computers, special purpose computers, and computing devices. Typically, a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in one or more computer programs, one or more scripts, or in other forms. The processing may be performed on one or more microprocessors, central processing units (CPUs), computing devices, microcontrollers, digital signal processors, or like devices or any combination thereof. Programs that implement the processing, and the data operated on, may be stored and transmitted using a variety of media. In some cases, hard-wired circuitry or custom hardware may be used in place of, or in combination with, some or all of the software instructions that can implement the processes. Algorithms other than those described may be used.

Programs and data may be stored in various media appropriate to the purpose, or a combination of heterogeneous media that may be read and/or written by a computer, a processor or a like device. The media may include non-volatile media, volatile media, optical or magnetic media, dynamic random access memory (DRAM), static ram, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge or other memory technologies. Transmission media include coaxial cables, copper wire and fiber optics, including the wires that comprise a system bus coupled to the processor.

Databases may be implemented using database management systems or ad hoc memory organization schemes. Alternative database structures to those described may be readily employed. Databases may be stored locally or remotely from a device which accesses data in such a database.

In some cases, the processing may be performed in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on an Intel® or AMD® processor, that are adapted to communicate with the computer. Any number and type of devices may be in communication with the computer.

A server computer or centralized authority may or may not be necessary or desirable. In various cases, the network may or may not include a central authority device. Various processing functions may be performed on a central authority server, one of several distributed servers, or other distributed devices.

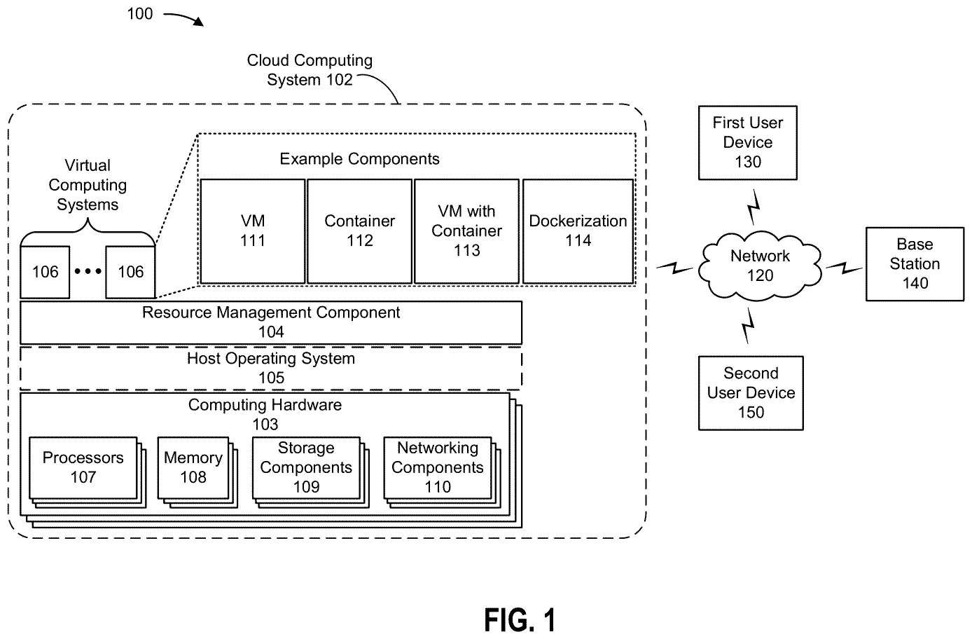

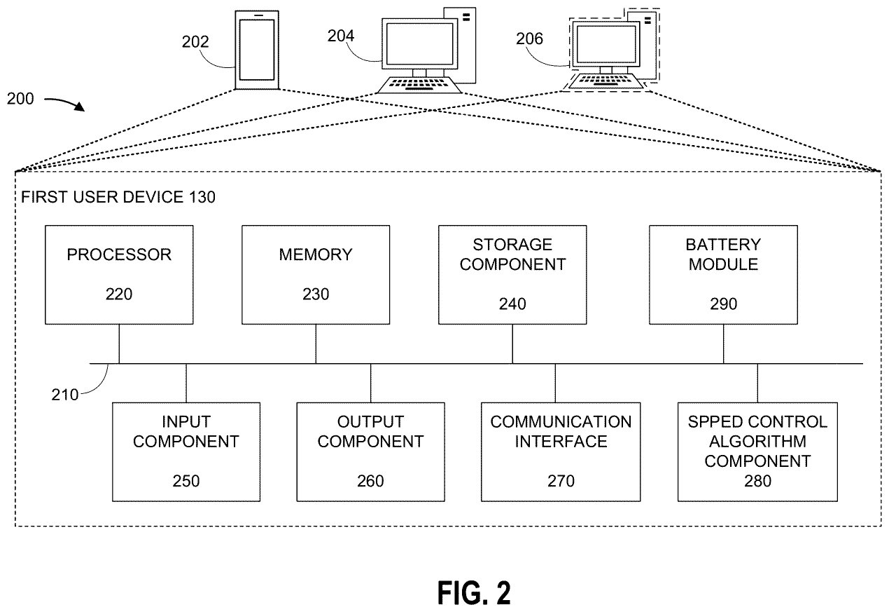

With reference to the figures and in particular, with reference to FIG. 1 and FIG. 2, these figures are example diagrams of data processing environments in which illustrative embodiments may be implemented. FIG. 1 and FIG. 2 are only examples and are not intended to assert or imply any limitation with regard to the environments in which different embodiments may be implemented. A particular implementation may make many modifications to the depicted environments based on the following description.

FIG. 1 is a diagram of an example environment 100 in which systems and/or methods described herein may be implemented. As shown in FIG. 1, the environment 100 may execute within a cloud computing system 102. The cloud computing system 102 may include one or more elements 103-113, as described in more detail below. As further shown in FIG. 1, the environment 100 may include a network 120, a first user device 130, and/or a base station 140. Devices and/or elements of the environment 100 may interconnect via wired connections and/or wireless connections. It is important to note that first user device 130, as described herein, is a user device which may be used by the first user and/or the second user. In the later case, when it is used by the second user, user device 130 may also be called a second user device 130. For purposes of convenience in reading this description, the embodiment of the user device 130 as a first user device will be described, but it should be understood as interchangeably termed “second user device” at least for the purposes of the disclosures of FIG. 1 and FIG. 2.

The cloud computing system 102 includes computing hardware 103, a resource management component 104, a host operating system (OS) 105, and/or one or more virtual computing systems 106. The resource management component 104 may perform virtualization (e.g., abstraction) of the computing hardware 103 to create the one or more virtual computing systems 106. Using virtualization, the resource management component 104 enables a single computing device (e.g., a computer, a server, and/or the like) to operate like multiple computing devices, such as by creating multiple isolated virtual computing systems 106 from the computing hardware 103 of the single computing device. In this way, the computing hardware 103 can operate more efficiently, with lower power consumption, higher reliability, higher availability, higher utilization, greater flexibility, and lower cost than using separate computing devices.

The computing hardware 103 includes hardware and corresponding resources from one or more computing devices. For example, the computing hardware 103 may include hardware from a single computing device (e.g., a single server) or from multiple computing devices (e.g., multiple servers), such as multiple computing devices in one or more data centers. As shown, the computing hardware 103 may include one or more processors 107, one or more memories 108, one or more storage components 109, and/or one or more networking components 110. Examples of a processor, a memory, a storage component, and a networking component (e.g., a communication component) are described elsewhere herein.

The resource management component 104 includes a virtualization application (e.g., executing on hardware, such as the computing hardware 103) capable of virtualizing the computing hardware 103 to start, stop, and/or manage the one or more virtual computing systems 106. For example, the resource management component 104 may include a hypervisor (e.g., a bare-metal or Type 1 hypervisor, a hosted or Type 2 hypervisor, and/or the like) or a virtual machine monitor, such as when the virtual computing systems 106 are virtual machines 111. Additionally, or alternatively, the resource management component 104 may include a container manager, such as when the virtual computing systems 106 are containers 112. In some implementations, the resource management component 104 executes within and/or in coordination with a host operating system 105.

A virtual computing system 106 includes a virtual environment that enables cloud-based execution of operations and/or processes described herein using computing hardware 103. As shown, the virtual computing system 106 may include a virtual machine 111, a container 112, a hybrid environment 113 that includes a virtual machine and a container, an environment which includes Docker-like filesystems or other possible Dockerization 114 with a VM or other computing hardware allocation, and/or the like. A virtual computing system 106 may execute one or more applications using a file system that includes binary files, software libraries, and/or other resources required to execute applications on a guest operating system (e.g., within the virtual computing system 106) or the host operating system 105.

The network 120 includes one or more wired and/or wireless networks. For example, the network 120 may include a cellular network, a public land mobile network (PLMN), a local area network (LAN), a wide area network (WAN), a satellite network, a private network, the Internet, and/or the like, and/or a combination of these or other types of networks. The network 120 enables communication among the devices of the environment 100.

First user device 130 may be possessed by a first user and includes one or more devices capable of receiving, generating, storing, processing, and/or providing information, as described elsewhere herein. First user device 130 may include a communication device and/or a computing device. For example, first user device 130 may include a wireless communication device, a mobile phone, a user equipment (UE), a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The base station 140 may support, for example, a cellular radio access technology (RAT). The base station may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the base station 140. The first user device 130 may transfer traffic between the base station 140 (e.g., using a cellular RAT), one or more base stations (e.g., using a wireless interface or a backhaul interface, such as a wired backhaul interface), and/or a core network. The first user device 130 may provide one or more cells that cover geographic areas.

The second user device 150 may be possessed by a second user and includes one or more devices capable of receiving, generating, storing, processing, and/or providing information, as described elsewhere herein. Second user device 150 may include a communication device and/or a computing device, and may be connected to, or embedded anywhere within, a vehicle or other equipment known to be utilized in the transportation industry. For example, second user device 150 may include a wireless communication device, a mobile phone, a vehicle computer system, a mobile printer, a calculator, a user equipment, a laptop computer, a tablet computer, a desktop computer, a set-top box, a wearable communication device (e.g., a smart wristwatch, a pair of smart eyeglasses, a head mounted display, or a virtual reality headset), or a similar type of device.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

FIG. 2 is a diagram of components of first user device 130, according to an example of the present disclosure. First user device 130 may include a bus 210, a processor 220, a memory 230, a storage component 240, an input component 250, an output component 260, a communication interface 270, and battery module 290.

Bus 210 includes a component that permits communication among the components of First user device 130. Processor 220 is implemented in hardware, firmware, or a combination of hardware and software. Processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some examples, processor 220 includes one or more processors capable of being programmed to perform a function. Memory 230 may include one or more memories such as a random access memory (RAM), a read only memory (ROM), and/or another type of dynamic or static storage device (e.g., a flash memory, a magnetic memory, and/or an optical memory) that stores information and/or instructions for use by processor 220. In some embodiments, a non-transitory computer-readable medium stores instructions that, when executed by a processor, cause the processor to perform various functions.

Storage component 240 stores information and/or software related to the operation and use of First user device 130. For example, storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 250 includes a component that permits first user device 130 to receive information, such as via user input (e.g., a touch screen display, a keyboard, a keypad, a mouse, a button, a switch, and/or a microphone). Additionally, or alternatively, input component 250 may include a sensor for sensing information (e.g., a GPS component, an accelerometer, a gyroscope, and/or an actuator). Output component 260 includes a component that provides output information from first user device 130 (e.g., a display, a speaker, a user interface, and/or one or more light-emitting diodes (LEDs)). Output component 260 may include a display providing a GUI, such as interface 300. Input component 250 and output component 260 may be combined into a single component, such as a touch responsive display, also known as a touchscreen.

Communication interface 270 includes a transceiver-like component (e.g., a transceiver and/or a separate receiver and transmitter) that enables first user device 130 to communicate with other devices, such as via a wired connection, a wireless connection, or a combination of wired and wireless connections. Communication interface 270 may permit first user device 130 to receive information from another device and/or provide information to another device. Communication interface 270 may include one or more RFFEs (radio frequency front ends) with antennae circuitry and RF (radio frequency) filters which may be variable power and/or purpose adapted for various communication frequencies, standards, links, and distances. For example, communication interface 270 may include an Ethernet interface, an optical interface, a coaxial interface, an infrared interface, an RF interface, a universal serial bus (USB) interface, a Wi-Fi interface, a cellular network interface, or the like.

Battery module 290 is connected along bus 210 to supply power to processor 220, memory 230, and internal components of first user device 130. Battery module 290 may supply power during field measurements by first user device 130. Battery module 290 permits First user device 130 to be a portable integrated device for conducting field measurements of propagation delay in a RAN.

First user device 130 may perform one or more processes described herein. First user device 130 may perform these processes by processor 220 executing software instructions stored by a non-transitory computer-readable medium, such as memory 230 and/or storage component 240. A computer-readable medium is defined herein as a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may instruct processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, first user device 130 may include additional components, fewer components, different components, or differently arranged components than those shown in FIGS. 2, 200. Additionally, or alternatively, a set of components (e.g., one or more components) of first user device 130 may perform one or more functions described as being performed by another set of components of first user device 130.

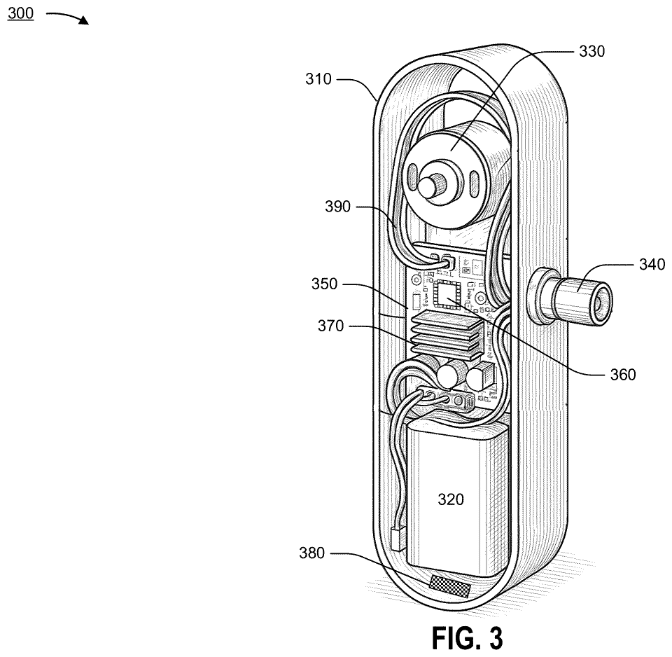

Referring to FIG. 3, which illustrates overall device internals 300 of a handheld tactile-stimulation system, the arrangement may depict a housing (internal enclosure) 310, a power source (battery pack) 320, a rotational drive (motor) 330, a power/adjustable speed control module switch 340, a controller (microcontroller on PCB) 350, a non-volatile memory 360, a motor driver/PWM stage 370, a USB port 380, and a wiring harness 390. It shall be appreciated that other embodiments may re-locate one or more modules, may integrate two or more of these blocks onto a single printed circuit board, or may introduce additional interface elements such as test pads, protective fuses, or environmental seals as example variations.

In some aspects, the housing (internal enclosure) 310 may provide a rigid, rounded, elongated cavity that may include internal bosses, rails, and standoffs to register electronic assemblies and the rotational drive. The housing (internal enclosure) 310 may be formed by a two-piece shell joined along a peripheral seam or by a monocoque chassis with a removable service panel. Preferably, the housing (internal enclosure) 310 includes dimensional datum features that may keep the motor axis colinear with a nose-end head coupler discussed in other figures, for instance. In various aspects, the housing (internal enclosure) 310 may include energy-absorbing ribs adjacent to the motor driver/PWM stage 370 to diffuse localized heat and may include molded cable channels that guide the wiring harness 390 toward the USB port 380 and away from moving elements.

In several aspects, the power source (battery pack) 320 may be a rechargeable cell or pack disposed within the housing (internal enclosure) 310 and may connect to the controller (microcontroller on PCB) 350 via a polarized connector. The power source (battery pack) 320 may include a protection circuit module that may provide over-current, over-voltage, and over-temperature protection. In some aspects, the power source (battery pack) 320 may be a single-cell Li-ion with a boost regulator or a multi-cell configuration with a buck regulator; capacity may be selected to enable multiple stroking sessions per charge, for example. In other aspects, the power source (battery pack) 320 may be removable to facilitate field replacement and recycling and may be mechanically retained by a bracket that also serves as a heat spreader for adjacent components.

In many aspects, the rotational drive (motor) 330 may be disposed toward a nose region so that its shaft axis aligns with a head coupler as depicted in other figures by way of example. The rotational drive (motor) 330 may include an integrated speed-reduction stage or may be coupled to a separate gear train, and it may be selected to provide low rotational speeds suitable for a non-vibratory slow-rotational stroking profile as described elsewhere. In some aspects, the rotational drive (motor) 330 may be a brushed coreless DC motor, a BLDC motor with commutation electronics on the controller (microcontroller on PCB) 350, or a gearmotor with an integrated planetary gearhead. Preferably, the rotational drive (motor) 330 may present a shaft end that accepts a bearing stack and coupler subassembly leading to the interchangeable head discussed in other figures, for instance.

In certain aspects, the power/adjustable speed control module switch 340 may provide an electrical interface that may route user input to the controller (microcontroller on PCB) 350. The power/adjustable speed control module switch 340 may be realized as a push-rotary encoder, a potentiometric dial, or a multi-position selector that may output discrete or continuous control signals. In some implementations, the power/adjustable speed control module switch 340 may also support a child-lock sequence by detecting timed or patterned actuation, and may include a debouncing network or a digital interface that communicates over I2C/SPI/UART to the controller (microcontroller on PCB) 350.

In some aspects, the controller (microcontroller on PCB) 350 may be disposed mid-body and may execute firmware stored in the non-volatile memory 360 to regulate the rotational drive (motor) 330. The controller (microcontroller on PCB) 350 may read a rotational-speed signal from a sensor (not separately labeled in FIG. 3) that may be implemented as a Hall-effect device at a coupler magnet, as an encoder integrated with the rotational drive (motor) 330, or as a commutation-derived estimator; any of these sensor realizations may produce a rotational-speed signal used for closed-loop regulation. In many aspects, the controller (microcontroller on PCB) 350 may compute a commanded duty cycle that may be applied by the motor driver/PWM stage 370 and may maintain a commanded low rotational speed suitable for gentle stroking contact as described in the system overview.

In various aspects, the non-volatile memory 360 may store calibration parameters that may include a commanded-speed-to-PWM-duty lookup adjusted for a speed-reduction train and a mapping between motor current and inferred contact force. The non-volatile memory 360 may further store preset definitions such as a lull preset, a drift preset, and a coast preset, as well as configuration data for a session auto-off duration and a child-lock enable state. In some implementations, the non-volatile memory 360 may also retain sanitation-cycle counters or an indication of last sanitation acknowledgment, and may preserve quality-control records created during factory provisioning.

In other aspects, the motor driver/PWM stage 370 may include a power MOSFET half-bridge or full-bridge and a gate-driver IC that may generate a pulse-width modulation motor drive signal at a PWM carrier frequency above an audible range. The motor driver/PWM stage 370 may be thermally coupled to a heat spreader or a finned sink visible on the PCB, and it may include a current-sense element such as a low-side shunt that may provide the controller (microcontroller on PCB) 350 with a motor-current signal. Preferably, the motor driver/PWM stage 370 may implement soft-start and soft-stop transitions to reduce electrical and mechanical transients, for example.

In several aspects, the USB port 380 may provide charging and/or a service interface that may connect to charge management circuitry on the controller (microcontroller on PCB) 350 or on an adjacent power management block. The USB port 380 may be a USB-C receptacle mounted through the sidewall and may be gasketed for splash resistance as described in other views. In certain aspects, the USB port 380 may also place the controller (microcontroller on PCB) 350 into a provisioning mode in which firmware and calibration parameters may be written to the non-volatile memory 360, and diagnostic logs may be read from the device in a wired service mode.

In many aspects, the wiring harness 390 may route discrete conductors and flat-flex jumpers between the power source (battery pack) 320, the USB port 380, the controller (microcontroller on PCB) 350, and the rotational drive (motor) 330. The wiring harness 390 may include strain relief features and may be guided by clips or channels molded into the housing (internal enclosure) 310 to minimize interference with airflow or moving parts. In some implementations, the wiring harness 390 may incorporate quick-disconnects at strategic locations to simplify assembly and service, and may be color-coded to reduce assembly errors.

In some aspects, a sensor configured to produce a rotational-speed signal may be integrated proximate to the head coupler (not shown in this internal view) or may be integrated into the rotational drive (motor) 330. The sensor configured to produce a rotational-speed signal may output pulses, quadrature signals, or analog waveforms which the controller (microcontroller on PCB) 350 may process to measure instantaneous and averaged speed. Preferably, a sampling strategy may be implemented such that the controller (microcontroller on PCB) 350 may compute duty adjustments at intervals that reduce steady-state error while avoiding audible artifacts in the rotational drive (motor) 330.

In several aspects, an operational flow within the internals 300 may proceed as follows. The power source (battery pack) 320 may supply regulated rails to the controller (microcontroller on PCB) 350 and the motor driver/PWM stage 370 after a power-on event. The power/adjustable speed control module switch 340 may provide an enable signal and a speed command input. The controller (microcontroller on PCB) 350 may read preset parameters and calibration lookups from the non-volatile memory 360, may acquire a rotational-speed signal from the sensor, and may compute a PWM duty cycle. The motor driver/PWM stage 370 may apply the computed PWM duty to the rotational drive (motor) 330, which may rotate a head coupler downstream of this figure. The controller (microcontroller on PCB) 350 may monitor a motor-current signal (if present) and a temperature signal (if a temperature sensor is included elsewhere on the PCB) and may adjust or derate motor drive conditionally.

In other aspects, physical interfaces on the PCB that carry the rotational-speed signal and motor-current signal may be protected by RC filters and ESD diodes, and firmware on the controller (microcontroller on PCB) 350 may implement outlier rejection, rate limiting of duty changes, and watchdog recovery routines. Preferably, the arrangement may support run-time presets such that a lull preset may ramp commanded speed smoothly, a drift preset may apply sinusoidal modulation around a nominal speed, and a coast preset may hold a substantially constant speed, for instance.

In various aspects, the internal mechanical packaging may exploit the housing (internal enclosure) 310 to improve balance and acoustics. The rotational drive (motor) 330 may be anchored to rigid posts to limit tilt. The controller (microcontroller on PCB) 350 and the motor driver/PWM stage 370 may be located centrally to distribute mass and may be separated from the power source (battery pack) 320 by a cable corridor that also promotes cooling. The wiring harness 390 may be wrapped or sleeved to prevent abrasion against the enclosure. The USB port 380 may be supported by a metal or polymer bracket that may spread insertion loads across the wall.

In several aspects, alternative embodiments may relocate the USB port 380 to an end face, may replace the power/adjustable speed control module switch 340 with capacitive touch inputs, or may integrate the non-volatile memory 360 as embedded flash within the controller (microcontroller on PCB) 350. The rotational drive (motor) 330 may alternatively be a low-speed BLDC unit controlled by a field-oriented controller in firmware, and the current-sense function may be implemented with an inline Hall sensor that may simplify ground layout. The sensor configured to produce a rotational-speed signal may alternatively be an optical interrupter coupled to a slotted disk on the gear output in builds where magnetic fields are constrained.

In some implementations, the internals 300 may also accommodate optional features described elsewhere, such as a tri-color indicator LED that may display charge state or lock state during provisioning, a tether anchor molded into the housing (internal enclosure) 310, or acoustic damping pads that may reduce structural-borne noise. Preferably, each optional element may be coupled to a spare connector or header such that variants may be produced without re-spinning the main board, for example.

In other aspects, assembly of the modules in the internals 300 may follow a sequence in which the rotational drive (motor) 330 is first installed and aligned, the controller (microcontroller on PCB) 350 with the motor driver/PWM stage 370 and the non-volatile memory 360 is populated and fastened, the power source (battery pack) 320 is routed and connected, and the wiring harness 390 is secured into clips within the housing (internal enclosure) 310. The USB port 380 may be torqued to a panel-mount specification, and a gasket or seal may be compressed to achieve a desired splash-resistance level. Post-assembly, the device may be placed into a provisioning mode through the USB port 380 so that firmware and calibration parameters may be written, after which functional tests may verify rotational-speed regulation under light load.

In many aspects, the internals 300 of FIG. 3 may thus provide structural, electrical, and control interconnections necessary for a handheld tactile-stimulation system that may regulate a commanded low rotational speed based on a rotational-speed signal and may drive an interchangeable head as described in other figures by way of example. The modular organization shown for the housing (internal enclosure) 310, the controller (microcontroller on PCB) 350, the non-volatile memory 360, the motor driver/PWM stage 370, the power source (battery pack) 320, the USB port 380, the rotational drive (motor) 330, the power/adjustable speed control module switch 340, and the wiring harness 390 may enable manufacturability, calibration, and serviceability across a range of configurations without limiting the disclosed technology to a single specific implementation.

In some aspects, quantitative specifications may assist in realizing the arrangement of the internals 300. The power source (battery pack) 320 may include a nominal voltage Vbatt between approximately 3.0 V and 8.4 V, a capacity between approximately 1500 mAh and 3200 mAh, and an internal resistance less than approximately 120 mΩ to limit voltage droop during transient demands. The rotational drive (motor) 330 may be selected to provide a torque constant Kt between approximately 10 and 25 mN·m/A and a back-EMF constant Ke between approximately 10 and 25 mV/rpm, such that the relation ω≈(Veff−I·Rm)/Ke may approximate unloaded speed, where Rm may denote motor winding resistance and Veff may denote effective drive voltage from the motor driver/PWM stage 370. The controller (microcontroller on PCB) 350 may implement a closed-loop update rate between approximately 200 Hz and 1 kHz and may filter rotational-speed measurements with a digital low-pass response (e.g., a first-order IIR with α between 0.1 and 0.4) to attenuate quantization ripple from the sensor while preserving responsiveness.

In various aspects, signal and power interactions may be defined at the board and harness level. The motor driver/PWM stage 370 may draw peak currents up to approximately 1.5-2.0 A for <100 ms during soft-start, with steady-state currents typically between approximately 60 mA and 300 mA at commanded low rotational speed. The wiring harness 390 may use conductors with cross-sectional area between approximately 0.05 and 0.2 mm² (e.g., 26-22 AWG) for motor phases or DC rails, and between approximately 0.02 and 0.05 mm² (e.g., 30-26 AWG) for sensor and control lines, and may include twisted pairs for sensor signals to reduce electromagnetic susceptibility. The USB port 380 may present a 5 V input that may be conditioned by a charge management IC; data lines D+ and D− may be routed as a differential pair at 90 Ω±10% impedance, with ESD protection diodes proximate to the connector footprint.

In several aspects, the firmware executing on the controller (microcontroller on PCB) 350 may be developed using C or C++ within an embedded toolchain (e.g., ARM-GCC) and may execute under a lightweight RTOS or a bare-metal loop. A control task may perform sensor acquisition, apply calibration parameters from the non-volatile memory 360, and compute duty updates using a proportional-integral (PI) law u[k]=u[k−1]+Kp(e[k]−e[k−1])+Ki·Ts·e[k], where e[k] may be the error between commanded and measured rotational speed, and Ts may be the control period. Preferably, anti-windup may be implemented by clamping the integral term and by a duty-rate limiter to mitigate audible artifacts. A separate I/O task may handle the power/adjustable speed control module switch 340 events, may debounce inputs, and may enact a child-lock sequence requiring a timed button pattern prior to enabling the control task output.

In other aspects, alternative rotational-speed sensing strategies may be supported. When a Hall-effect sensor is integrated near the head coupler (not shown in FIG. 3), the sensor may produce pulses at a rate proportional to speed f=(N/60)·rpm for N pole pairs; the controller (microcontroller on PCB) 350 may compute rpm by measuring inter-pulse intervals with a hardware timer capture. When a commutation-inferred estimator is used, the controller (microcontroller on PCB) 350 may infer speed from back-EMF zero crossings filtered by the motor driver/PWM stage 370 sense network and may apply a calibration map stored in the non-volatile memory 360 to compensate for load-dependent slip.

In some embodiments, thermal management may be addressed through conduction and derating. The motor driver/PWM stage 370 may include a thermal pad soldered to a copper pour that may be coupled to the housing (internal enclosure) 310 by a thermal interface pad; an effective thermal resistance to ambient may be between approximately 20 and 45° C./W, depending on wall thickness and contact area. A temperature signal from a sensor (if placed adjacent to the driver) may be sampled at approximately 10 Hz and may trigger duty derating above approximately 60° C. internal temperature following a linear or stepped profile stored in the non-volatile memory 360.

In many aspects, EMC and safety considerations may be implemented at the internals 300 level. Input filtering at the power source (battery pack) 320 node may include an LC filter with a cutoff between approximately 1 kHz and 5 kHz and damping to avoid peaking. The motor driver/PWM stage 370 gate transitions may be edge-controlled to limit di/dt, and snubbers may be installed across motor terminals to reduce conducted emissions. Creepage and clearance around the USB port 380 may follow 5 V SELV guidelines, and over-current protection may be provided by a resettable polymeric fuse in series with the 5 V input.

In certain aspects, the modularity of the internals 300 may enable configuration variability. The controller (microcontroller on PCB) 350 and the non-volatile memory 360 may be consolidated into a single package when an MCU with sufficient embedded flash is used, or they may be separated to allow larger preset libraries. The rotational drive (motor) 330 may be swapped for a unit with different gear ratios (e.g., 20:1, 30:1, 50:1) to tailor torque-speed characteristics without modifying the controller (microcontroller on PCB) 350 firmware, with the mapping tables in the non-volatile memory 360 updated during provisioning.

In several aspects, the USB port 380 may additionally support a service protocol. A virtual COM (CDC-ACM) interface may be exposed for diagnostics; a command set may include reading and writing of calibration tables, querying real-time speed and current telemetry, and initiating a self-test routine that may step commanded speed across a small set of values while capturing sensor readings. Preferably, a bootloader mode may be invoked by holding the power/adjustable speed control module switch 340 during insertion of a USB cable, thereby allowing firmware updates without opening the housing (internal enclosure) 310.

In some implementations, mechanical tolerances at the internals 300 may be specified to maintain the non-vibratory slow-rotational stroking profile. The motor mounting plane in the housing (internal enclosure) 310 may be flat within approximately 0.05-0.10 mm; the motor shaft concentricity relative to the housing datum may be controlled within approximately 0.1-0.2 mm; and the PCB standoffs may maintain board coplanarity within approximately 0.15 mm to prevent connector stress at the USB port 380. The wiring harness 390 may be secured with clips at intervals between approximately 20 and 40 mm to avoid contact with the rotational drive (motor) 330.

In various aspects, the internal power architecture may be segmented. A buck or boost converter stage may supply a regulated logic rail (e.g., 3.3 V) to the controller (microcontroller on PCB) 350, the non-volatile memory 360, and sensors, while a separate supply may feed the motor driver/PWM stage 370. UVLO thresholds may be configured to prevent brownout during high current transients; a hysteretic margin between approximately 200 and 400 mV may be employed to avoid chatter.

In other aspects, data flow within the internals 300 may be described in terms of signals and their timing. A “commanded speed” variable may be updated by the I/O task upon changes at the power/adjustable speed control module switch 340. A “measured speed” variable may be updated every control tick from the sensor reading. A “duty request” may be computed by the control task and sent to the motor driver/PWM stage 370 via a hardware PWM channel or a gate driver interface. Telemetry buffers may be populated with decimated samples (e.g., at 10 Hz) and may be persisted to the non-volatile memory 360 intermittently or streamed via the USB port 380 in service mode.

In some embodiments, the internals 300 may be adapted for institutional or industrial environments. The power source (battery pack) 320 may include a keyed connector to prevent polarity reversal during service. The housing (internal enclosure) 310 may include an internal tether anchor (unlabeled in FIG. 3) that may mate to an external tether shown in a later view. The USB port 380 may be mechanically recessed to reduce snag risk and may include a removable dust cover.

In some embodiments, electrical/control schematic 700 may further depict signal paths from the rotation sensor to the controller (microcontroller on PCB) 350 and from the controller to the motor driver/PWM stage 370, providing an example of the closed-loop regulation referenced in the internals 300.

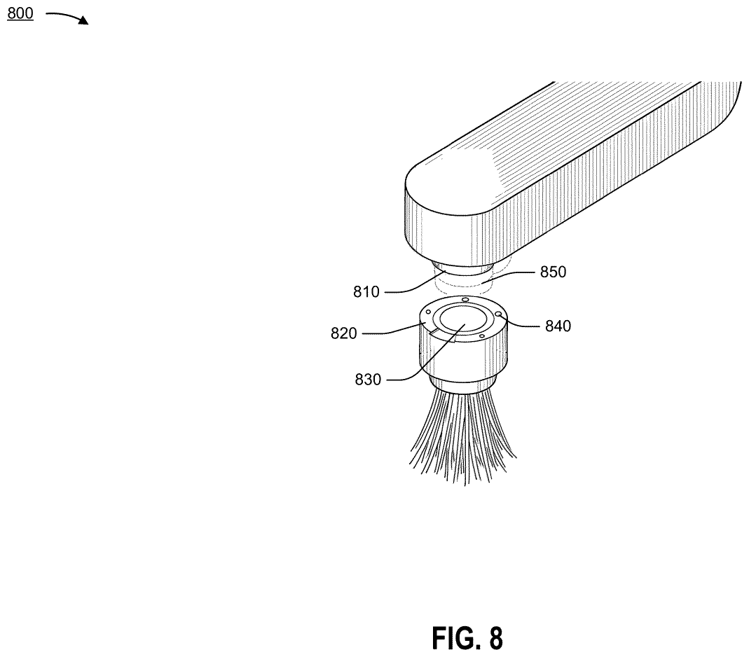

For instance, in the example illustrated in FIG. 8, a magnetic quick-connect interface may couple the rotational drive (motor) 330 output shaft to a head coupler, where axial retention and anti-rotation features cooperate with balance considerations originating at the internals 300.

In several aspects, manufacturing and quality processes may be tightly coupled to the internals 300 architecture. A provisioning fixture may access the USB port 380 and may clamp the housing (internal enclosure) 310 to a datum, allowing repeatable calibration and verification. The controller (microcontroller on PCB) 350 may expose a test mode that may step the rotational drive (motor) 330 through specified duty values while a tachometer measures speed; the collected data may be used to populate the commanded-speed-to-PWM-duty lookup in the non-volatile memory 360. A magnet pull-force test and runout measurement (performed downstream at the nose assembly) may be recorded alongside the firmware identifiers to the same memory for traceability.

In some aspects, reliability features may be implemented at the internals 300 level. The controller (microcontroller on PCB) 350 may include a watchdog timer that may be kicked by the control task; a failure to kick may result in a safe reset and motor disable. Brownout detection may prevent unintended behavior during low-voltage conditions. The motor driver/PWM stage 370 may include current limiting to mitigate stall or over-force conditions; the threshold may be calibrated and stored in the non-volatile memory 360.

In many aspects, software interfaces may be architected for longevity and compatibility. The preset structures stored in the non-volatile memory 360 may be versioned, and the controller (microcontroller on PCB) 350 may include a migration routine that may adapt older records to newer formats. A CRC or similar integrity check may be appended to calibration tables to detect corruption; upon detection, a default profile may be loaded and a service flag may be raised via the USB port 380.

In certain aspects, human-factors considerations may influence the internals 300 layout. The power/adjustable speed control module switch 340 harness routing may be separated from high-dv/dt nodes at the motor driver/PWM stage 370 to prevent touch-induced artifacts. The housing (internal enclosure) 310 wall thickness near the rotational drive (motor) 330 may be tuned to reduce panel vibration modes that could otherwise couple into audible noise. The PCB mounting geometry may position the controller (microcontroller on PCB) 350 away from standoff bosses to minimize tactile feel of internal resonance.

In some embodiments, additional mechanical datum features within the housing (internal enclosure) 310 may be defined to improve repeatability of production alignment. It shall be noted that dowel-style locator pins may be integrally molded adjacent to the rotational drive (motor) 330 seat, and a counterbored boss may constrain axial float of the motor bearing to within approximately 0.05 mm, thereby reducing cumulative runout at the head coupler interface described elsewhere.

In several aspects, the wiring harness 390 may be augmented with shielded segments where the motor driver/PWM stage 370 high-dv/dt nodes could couple into the sensor configured to produce a rotational-speed signal. It shall be noted that a braided shield may be tied to chassis ground at a single point near the USB port 380 to avoid ground loops, and that differential sensor pairs may be routed with controlled spacing to approximate 100 Ω impedance where an encoder output is differential. In some embodiments, an RC snubber across the motor terminals may be tuned using Zobel network principles (Rsnub≈Requiv, Csnub≈1/(2π·Rsnub·fc)) to place a pole below a selected corner frequency, thereby reducing conducted emissions without overdamping the system.

In many aspects, the controller (microcontroller on PCB) 350 may further include firmware hooks to log transient events directly into the non-volatile memory 360. It shall be noted that sampled tuples (timestamp, commanded speed, measured speed, motor current, temperature) may be buffered and, upon fault detection or end-of-session, may be written atomically using a double-buffered record layout to preserve integrity even under power removal.

In some embodiments, modularity of the internals 300 may be leveraged to deploy variant BOMs without redesigning the PCB. It shall be noted that the non-volatile memory 360 may store a device “capability manifest” that enumerates present modules (e.g., rotation sensor type, gear ratio, thermistor present/absent), and the controller (microcontroller on PCB) 350 may adapt the control law accordingly (e.g., switching from pulse timing to back-EMF estimation).

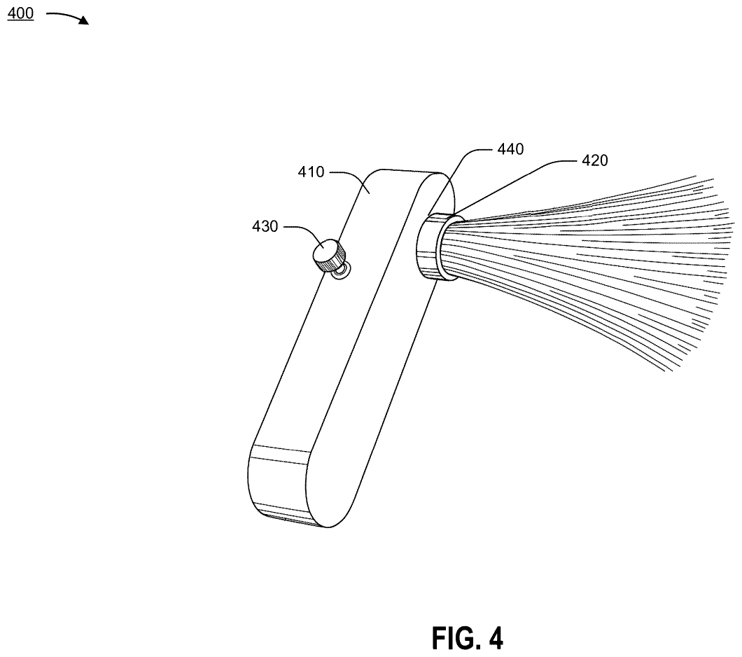

Furthermore, the internals 300 may be used across a variety of industry and technological domains. In some embodiments, wellness and spa environments may benefit from sealed USB port 380 charging and quick sanitation logging; in healthcare adjunct settings, the buffered logs may support institutional compliance workflows; in hospitality, the modular power source (battery pack) 320 may enable rapid hot-swap operations; and in consumer home environments, the quiet PWM operation of the motor driver/PWM stage 370 may reduce perceived noise. It shall be noted that ergonomics influenced by the housing (internal enclosure) 310 interior layout may allow compact exterior geometries in FIG. 4 while maintaining thermal margins for longer sessions.

The internals 300 arrangement may yield technical benefits over conventional open-loop handheld massagers. Firstly, unlike conventional techniques that solely drive a motor at a nominal voltage, the controller (microcontroller on PCB) 350 may regulate commanded low rotational speed using measured rotational-speed signals and calibrated duty mappings, which may maintain consistent stroking profiles across battery state and contact load. Secondly, in some embodiments, separation of logic and motor rails and shielded wiring harness 390 segments may reduce electromagnetic coupling into sensing, which may improve measurement fidelity and reduce audible artifacts. Thirdly, the provisioning sequence through the USB port 380 may embed device-specific calibration and manifest data into the non-volatile memory 360, which may support consistent performance across manufacturing lots and field replacements.

It shall be noted that these disclosures may be adapted to additional sectors, including sensory research labs, airline lounge relaxation pods, and occupational therapy clinics. In some embodiments, compliance metrics captured internally via the controller (microcontroller on PCB) 350 and persisted in the non-volatile memory 360 may be exported periodically via the USB port 380 during maintenance windows for fleet analytics, while preserving the on-device, autonomous runtime disclosed herein.

Referring to FIG. 4, which illustrates an overall external assembly 400 of a handheld tactile-stimulation system, the depiction may present a housing (external enclosure) 410, an interchangeable head (installed) 420, a push-rotary user control 430, and a head coupler nose 440. It shall be appreciated that other embodiments may reposition the push-rotary user control 430 or may substitute alternate coupler geometries at the head coupler nose 440 while maintaining the same functional relationships described herein.

In some aspects, the housing (external enclosure) 410 may provide the “housing” recited for a handheld tactile-stimulation system and may define an elongated, radiused outer profile that may be sized for single-hand grasp. The housing (external enclosure) 410 may include a continuous top surface that may facilitate thumb access to the push-rotary user control 430 and a slightly flattened bottom region that may act as a benchtop resting surface. The housing (external enclosure) 410 may be formed from a two-piece molded shell or an additively manufactured body and may enclose a power source disposed within the housing as described with respect to internal views. Preferably, the housing (external enclosure) 410 may include internal bosses aligned to a motor axis that may continue through the head coupler nose 440 to promote low runout during rotation, for instance. In various aspects, the housing (external enclosure) 410 may be configured to provide splash resistance at least to IPX4 using seals or overmolded joints not visible in this view, and may include material selections such as PC-ABS, recycled-content polymers, or TPE overmolds in grip areas as discussed elsewhere.

In certain aspects, the interchangeable head (installed) 420 may correspond to a “removable, interchangeable head attachable to the head coupler.” The interchangeable head (installed) 420 may include flexible filaments configured for gentle stroking contact against human skin and, in some implementations, may include a ferrule that retains a plurality of filament sub-bundles with a proximal stiffness-tuning structure as further detailed in separate figures. The interchangeable head (installed) 420 may be attached in this view and may be seated coaxially to the head coupler nose 440 such that a shoulder of the ferrule abuts a registration feature on the nose. Preferably, the interchangeable head (installed) 420 may be configured to detach tool-lessly, enabling washing and interchange between filament materials, lengths, and flare angles selected to create different tactile profiles. In several aspects, the interchangeable head (installed) 420 may cooperate with an internal magnetic quick-connect interface and a keyed anti-rotation feature (not visible externally) to constrain angular slip during gentle skin contact while allowing controlled axial removal, for example.

In many aspects, the push-rotary user control 430 may provide the “user control comprising a push-rotary knob providing ON/OFF enable and continuous speed selection,” and may be located to allow thumb operation while the housing (external enclosure) 410 is grasped. The push-rotary user control 430 may be realized as a rotary encoder with an integrated momentary push, a potentiometer with a separate digital press detection, or a multi-function knob that may communicate position and events to a controller internal to the housing. Preferably, the push-rotary user control 430 may include tactile detents that may provide discrete feedback to a user without imparting vibration to the interchangeable head (installed) 420. In some implementations, the push-rotary user control 430 may further serve as an input for a child-lock state by recognizing a long-press or a timed sequence and may include visual or audible indicators associated with state changes.

In various aspects, the head coupler nose 440 may provide an exteriorized portion of a “head coupler” to which the interchangeable head (installed) 420 may be attached. The head coupler nose 440 may be formed as a circular boss or a recessed seat that may center and axially support the ferrule of the interchangeable head (installed) 420. The head coupler nose 440 may, in some embodiments, hide a magnetic quick-connect interface comprising a permanent-magnet element and may mate with a ferromagnetic counterface within the interchangeable head (installed) 420. Preferably, a keyed anti-rotation feature may be integrated into the head coupler nose 440 such as a spline, a flat, or a detent-index geometry that may seat with a corresponding geometry in the interchangeable head (installed) 420 to constrain relative angular misalignment during slow rotation, for instance. In other embodiments, a bayonet latch, a threaded collet, or a kinematic seat may be used instead of or in addition to magnetics to accommodate alternative sanitation or retention requirements.

In some aspects, the overall external assembly 400 may physically embody the primary functional relationships of the handheld tactile-stimulation system. A controller internal to the housing (external enclosure) 410 may be configured to regulate a rotational drive based on a rotational-speed signal to maintain a commanded low rotational speed at the head coupler nose 440 while the interchangeable head (installed) 420 is attached. The push-rotary user control 430 may provide a speed command and an enable input to the internal controller. The head coupler nose 440 may continue the motor axis to the exterior such that the interchangeable head (installed) 420 may rotate substantially concentrically with low runout when the system operates in a non-vibratory slow-rotational stroking profile. In several embodiments, the exterior geometry may be arranged to provide working clearance for the filament envelope so that the flexible filaments of the interchangeable head (installed) 420 may sweep across a target surface without interference from the housing (external enclosure) 410.

In other aspects, the housing (external enclosure) 410 may integrate additional external features. A grip contour may be molded into the rear third of the housing (external enclosure) 410 to improve in-hand stability during self-application to scalp or back regions. A small aperture for a tether anchor may be placed near the butt end (not shown in this view) and may accept a security tether for facility use. A charging or service interface may be located on a side or end face (see other views) and may be sealed by a gasket to support wipe-down cleaning practices. Preferably, exterior corners may be radiused and seams may be flush to reduce debris accumulation and to facilitate sanitation workflows.

In many aspects, the interchangeable head (installed) 420 depicted in this external view may represent one of multiple head options in a head kit. The interchangeable head (installed) 420 may employ flexible filaments selected from medical-grade silicone in Shore 00-20 to A-10, nylon 6/12 monofilaments, or feather-analog microfibers, each of which may be washable and replaceable. In some implementations, mixed-length filament arrays may be used to create layered stroking cues, dual-durometer filaments may be introduced to vary bending stiffness along the filament length, or micro-textured tips may be included to increase perceived stroking breadth at a given contact force. Color or symbol coding may be used on the head ferrule or collar to indicate stiffness class or intended region (e.g., scalp, back, forearm), and these markings may be useful for institutional rotation and sanitation protocols.

In certain aspects, the push-rotary user control 430 may cooperate with internal presets stored in non-volatile memory such that a user may select a lull preset that ramps speed between two values, a drift preset that applies sinusoidal modulation around a nominal speed, or a coast preset that holds a substantially constant speed. The push-rotary user control 430 may, optionally, include a ring light or an adjacent indicator that may present battery state-of-charge or lock state information in high-contrast patterns for accessibility. Preferably, detent spacing and torque may be selected to balance accidental motion resistance with ease of adjustment in a single-hand grasp.

In some embodiments, the head coupler nose 440 may be engineered to limit cumulative wear during repeated head swaps. A wear surface or registration plate may be incorporated at the coupling face to resist galling and to maintain axial registration across many attachment cycles. The head coupler nose 440 may include chamfers or lead-in radii that may assist guided attachment. The keyed anti-rotation feature may be shallow so that the interchangeable head (installed) 420 may seat without excessive insertion force while still regulating angular alignment under gentle skin contact loads. In alternative embodiments, the head coupler nose 440 may present a shallow conical seat to improve centering prior to magnetic capture.

In various aspects, the housing (external enclosure) 410 may be designed to support low acoustic noise during steady operation. The wall thickness and internal ribbing may be tuned to avoid panel resonance at typical rotational speeds used in presets. The exterior surface finish may be selected to provide a low-friction, easy-to-clean surface that may tolerate alcohol wipes or common detergents without discoloration. Preferably, the housing (external enclosure) 410 may be formed with seam geometry that may shed liquids away from the head coupler nose 440 and away from the push-rotary user control 430 to reduce intrusion into internal cavities.

In other implementations, the overall external assembly 400 may incorporate optional accessibility features. The push-rotary user control 430 may accept gloved operation by increasing knob diameter or by adding radial knurls. The housing (external enclosure) 410 may present tactile index marks or shallow ribs to assist blind orientation. Visual indicators adjacent to the push-rotary user control 430 may be implemented with high-contrast colors and simple iconography such that users may quickly identify enable states and preset selections.

In some aspects, the external geometry of the housing (external enclosure) 410, the head coupler nose 440, and the interchangeable head (installed) 420 may be co-designed to maintain a consistent approach angle to the target surface and to limit off-axis loads. The longitudinal centerline of the housing (external enclosure) 410 may angle slightly relative to the head coupler nose 440 to facilitate wrist-neutral sweeping paths along the scalp or back. Preferably, the distance from the push-rotary user control 430 to the head coupler nose 440 may be chosen so that a user may modulate speed without obstructing the filament envelope during operation.

In many embodiments, the overall external assembly 400 may therefore present a cohesive arrangement in which the housing (external enclosure) 410 supports internal electronics and the rotational drive, the head coupler nose 440 provides a precise mechanical interface for head attachment, the interchangeable head (installed) 420 provides the gentle stroking contact surface, and the push-rotary user control 430 provides user input for enablement and speed selection. The exterior view may thus cooperate with internal subsystems to realize a handheld tactile-stimulation system that may regulate a commanded low rotational speed based on a rotational-speed signal and may deliver a non-vibratory slow-rotational stroking profile when used with appropriate filament heads.

In other aspects, manufacturing and service considerations may inform the features visible in FIG. 4. The head coupler nose 440 geometry may accept a factory alignment gauge during quality control to verify runout. The push-rotary user control 430 may be retained by a threaded bushing or a snap-fit collar accessible from inside the housing (external enclosure) 410. The interchangeable head (installed) 420 may include an internal ferromagnetic counterface that may be compatible with a magnet pull-force window verified at provisioning. Preferably, exterior tolerances may be set to ensure repeatable sealing engagement around any panel-mounted port shown in other views while avoiding deformation that could affect the alignment at the head coupler nose 440.

In several alternative embodiments, the overall external assembly 400 may omit the push-rotary user control 430 in favor of a low-profile slider or capacitive touch strip; may place the head coupler nose 440 on an angled face to orient the filament sweep; or may integrate a removable decorative bezel around the head interface that may be replaceable for color-coding or cleaning. The housing (external enclosure) 410 may also incorporate a subtle flat or foot to discourage the device from rolling when set down with the head attached.

In summary, FIG. 4's external arrangement may enable a practitioner to understand how the housing (external enclosure) 410, the interchangeable head (installed) 420, the push-rotary user control 430, and the head coupler nose 440 interrelate to realize a handheld configuration that may house a power source and control electronics, may accept removable heads for gentle stroking contact, and may provide user-selectable operation of a commanded low rotational speed regulated by an internal controller based on a rotational-speed signal.

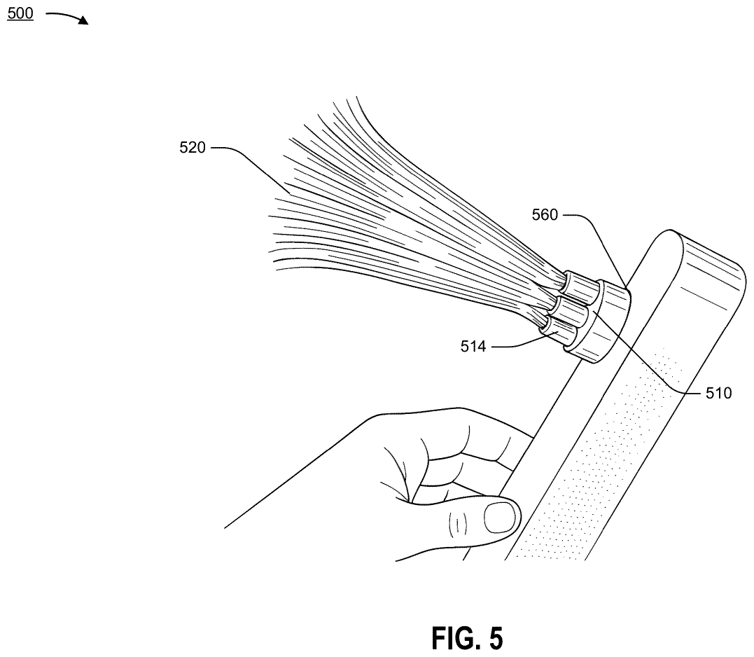

Referring to FIG. 5, which illustrates a close-up head detail 500 of a removable, interchangeable head attachable to a head coupler for a handheld tactile-stimulation system, an overall head detail 500 may be configured to present flexible filaments for gentle stroking contact against human skin while being adapted to rotate at a commanded low rotational speed. It shall be appreciated that other embodiments may implement mechanically or materially different end-effector geometries that remain consistent with an interchangeable head attachable to the head coupler and regulated rotation as described elsewhere.

In some aspects, a ferrule 510 may be implemented as a generally cylindrical or slightly tapered coupling body that interfaces to a device-side head coupler and that mechanically seats the interchangeable head against an alignment shoulder at the housing nose. The ferrule 510 may define an internal cavity sized to retain filament sub-bundles, to accept adhesive or crimp features, and to transmit torque from the rotational drive without appreciable slip. In an example, the ferrule 510 may include an interior counterbore that receives a coupler stub and may define a face that bears against a nose-side registration surface to manage axial loads that may arise during light skin contact, for instance.

In various aspects, a proximal stiffness-tuning structure 514 may be arranged adjacent to a filament exit throat of the ferrule 510 to shape the near-root bending characteristics. The proximal stiffness-tuning structure 514 may include an annular elastomeric ring, a molded throat with reduced diameter, a short section of higher-durometer sleeve, or a spring collar that collectively may increase local stiffness near the ferrule while preserving distal compliance of the filaments. Preferably, the proximal stiffness-tuning structure 514 is dimensioned to establish a boundary condition that may be repeatable across head variants so that commanded speed profiles may translate to consistent tactile envelopes across materials and lengths, for example.

In several aspects, flexible filaments 520 may extend outward from the ferrule 510 and may include a plurality of filament elements intended for gentle stroking contact. The flexible filaments 520 may be realized using medical-grade silicone in a Shore hardness range of 00-20 to A-10, nylon 6 or nylon 12 monofilaments, or feather-analog microfibers, and may be washable and replaceable. In some implementations, the flexible filaments 520 may include micro-textured tips that may increase perceived stroking breadth at a given contact force while maintaining low normal force at the skin. In other aspects, the flexible filaments 520 may be cut or molded to a flared profile to distribute contact and may be trimmed to correspond to scalp, back, or forearm presets described with respect to other figures.

In certain aspects, filament sub-bundles may be arranged within the ferrule 510 as discrete cluster units that allow controlled filament density and flare geometry. The filament sub-bundles may be potted using a medical-grade silicone adhesive, crimp-captured by a metallic sleeve, or held by a compression collet that may facilitate replacement. In some implementations, the filament sub-bundles may include mixed filament diameters or dual-durometer construction, where a central core may include stiffer elements and a peripheral layer may include softer elements to produce layered stroking cues under slow rotation, for instance. In several aspects, the filament sub-bundles may be indexed relative to a keyed feature in the ferrule 510 so that repeatable angular distribution may be achieved when the interchangeable head is serviced or re-packed.

In many aspects, the ferrule 510 may optionally cooperate with a magnetic quick-connect interface that may reside on the device side. The ferrule 510 may present a ferromagnetic counterface that may be attracted to a device-side permanent-magnet element and may engage a keyed anti-rotation feature for angular repeatability. While these coupling elements may not be visible in the view of FIG. 5, the ferrule 510 may nevertheless define a proximal face and internal geometry compatible with a magnetic quick-connect interface that could also include a wear/registration plate on the device nose to manage surface galling and to maintain concentricity.

In some aspects, the geometry of the ferrule 510 may be selected to support dynamic balance and low runout during rotation. The ferrule 510 may include an external shoulder that abuts a device-side nose boss so that radial reaction forces may be carried across a broad surface rather than a point contact. The ferrule 510 may further include a concentricity tolerance relative to the filament exit throat such that total indicated runout at the head coupler may be held to a limit during operation at low rotational speeds. In other aspects, a small chamfer at the ferrule mouth may be used to reduce stress concentrations at the filament root and to mitigate wear of the proximal stiffness-tuning structure 514.

In various aspects, the flexible filaments 520 may be sized and arranged to operate effectively within slow-rotational stroking presets stored by a controller elsewhere in the system. The flexible filaments 520 may be cut to lengths selected from at least two of 20 mm, 35 mm, and 50 mm in alternate heads to offer layered tactile profiles. In some implementations, the flexible filaments 520 may be arranged in a hemispherical bundle suitable for scalp contact, whereas in other implementations, the flexible filaments 520 may be arranged in a conical flare suitable for broad swaths along the back. Preferably, the polymer selection for the flexible filaments 520 may account for washability, biocompatibility, and damping so that audible rustle may remain low, for example.

In some aspects, the filament sub-bundles may be created as replaceable cartridges that may be removed from the ferrule 510 without tools. The filament sub-bundles may include a small tang or notch that aligns with an interior slot of the ferrule 510 to ensure correct placement. In other aspects, the filament sub-bundles may be permanently potted, and the entire interchangeable head may be swapped at end-of-life. In several aspects, the ferrule 510 may itself be part of a head module that may withstand repeated sanitization cycles, and the flexible filaments 520 may include antimicrobial additives or color bands that may indicate stiffness class for institutional settings.

In certain aspects, the proximal stiffness-tuning structure 514 may be adjustable in the field to tailor perceived stiffness. The proximal stiffness-tuning structure 514 may be realized as a removable elastomeric ring that may be moved along the filament root region to vary its effective bending length, or as a threaded collar that may compress a compliant sleeve to change the throat diameter. In other aspects, the proximal stiffness-tuning structure 514 may be internal and non-removable to avoid user tampering while still providing consistent near-root stiffness.

In several aspects, manufacturability and assembly of the ferrule 510 and filament sub-bundles may be performed using a repeatable fixture. The ferrule 510 may be held in a concentric collet while the filament sub-bundles are inserted and potted, and a gauge may be applied at the ferrule mouth to ensure even flare of the flexible filaments 520 after curing. In other aspects, a crimp die may be used to capture the filament sub-bundles with a controlled crimp height that may correlate with pull-out strength and creep resistance under rotation. Preferably, the resulting assembly may then be dynamically evaluated to verify balance prior to packaging as an interchangeable head.

In many aspects, the flexible filaments 520 and the ferrule 510 may cooperate with controller behaviors described in other figures. The flexible filaments 520 may be driven at low commanded speeds so that centrifugal flaring remains modest and contact forces remain gentle. The ferrule 510 may include features that allow the device to infer presence or absence of the head, such as a magnetic field magnitude target when seated against a device-side magnet. In some implementations, the ferrule 510 may include a passive identifier that may be readable during a service mode to facilitate preset selection or sanitation logging, although such features may be optional and not required for operation.

In other aspects, cleaning and sanitation of the head detail 500 may be facilitated by material choices and mechanical design. The flexible filaments 520 may be compatible with soap-and-water washing, and the ferrule 510 may include drain or vent paths to prevent liquid entrapment at the proximal stiffness-tuning structure 514. Preferably, the ferrule 510 may be formed from stainless steel or anodized aluminum to resist corrosion and to maintain appearance after repeated cleaning cycles, for instance.

In various aspects, the geometry of the head detail 500 may be adapted to additional use cases while remaining within the disclosed framework. The flexible filaments 520 may include tapered or twisted sections to modify damping and perceived texture. The filament sub-bundles may be arranged in different angular patterns (e.g., tri-lobed, ring-dense core, or sparse periphery) to change stroking breadth. The proximal stiffness-tuning structure 514 may be paired with alternative ferrule 510 throat geometries that may establish a progressive stiffness gradient from root to tip.

In several aspects, the head detail 500 may interface with a keyed anti-rotation feature that may be present on the device-side coupler. The ferrule 510 may include a shallow groove or flat that may engage a corresponding key so that angular slip may be limited when light lateral forces are applied during self-use. While the key may be internal and not depicted in FIG. 5, the ferrule 510 may be machined to accept the key depth and width according to a tolerance stack that may preserve axial seating and minimize rattling during rotation, for instance.

In some aspects, the overall head detail 500 may be scaled to multiple device sizes. The ferrule 510 outer diameter may vary to match different head coupler diameters while preserving filament exit geometry. The flexible filaments 520 may scale in count to maintain surface coverage, and the filament sub-bundles may scale in cross-section so that potting volumes remain manageable. The proximal stiffness-tuning structure 514 may also scale so that boundary-condition effects remain proportionally similar across product tiers.

In certain aspects, quality control for the head detail 500 may include verification of pull-out strength of the filament sub-bundles, concentricity of the ferrule 510 bore to the filament exit throat, and consistency of the proximal stiffness-tuning structure 514 compression or geometry. The flexible filaments 520 may be evaluated for length tolerance, diameter variance, and tip finish, and the assembled head may be checked for dynamic runout when rotated at exemplar low speeds. Preferably, heads that meet tolerance targets may be kitted into interchangeable head sets aligned with region-specific presets.

In many aspects, the head detail 500 as depicted in FIG. 5 may thus provide a removable, interchangeable head attachable to the head coupler that may include the ferrule 510, the proximal stiffness-tuning structure 514, the flexible filaments 520, and the filament sub-bundles, each cooperating to enable a non-vibratory slow-rotational stroking profile when driven at a commanded low rotational speed by the handheld tactile-stimulation system.

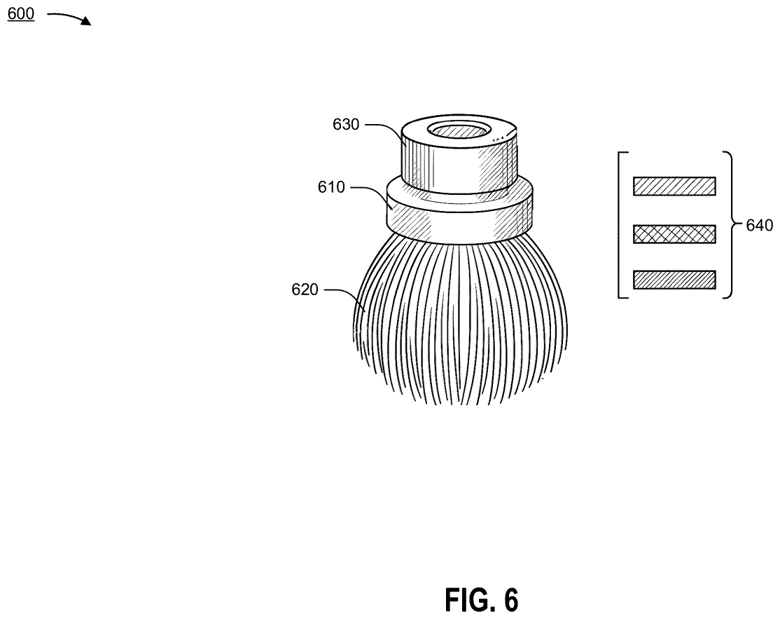

Referring to FIG. 6, which illustrates an overall alternative head 600 configured as a removable, interchangeable head attachable to a head coupler for a handheld tactile-stimulation system, an overall alternative head 600 may be constructed to provide flexible filament contact at a commanded low rotational speed and may be swapped tool-lessly to alter tactile profiles for different body regions. It shall be appreciated that other embodiments may rearrange subcomponents or adopt different coupling geometries while remaining consistent with an interchangeable head attachable to the head coupler and regulated slow-rotational stroking.

In some aspects, a head module body 630 may include a compact ferrule subassembly that provides structural support and torque transmission during slow rotation. The head module body 630 may be machined from metallic stock, molded from engineering polymer, or formed as a composite housing, and may define concentric datum surfaces that seat against a device-side nose to control axial position and radial alignment. In other aspects, the head module body 630 may incorporate an internal bore sized to receive a coupler stub and may interface to an anti-rotation feature on the device so that slip may be reduced during gentle off-axis contact, for instance.

In various aspects, a ferrule coupler (removable) 610 may be formed at the proximal end of the head module and may define the mating geometry to a device-side coupler. The ferrule coupler (removable) 610 may include a flat proximal face that abuts a wear/registration plate on the device, and may further include a ferromagnetic counterface when a magnetic quick-connect interface is used. Preferably, the ferrule coupler (removable) 610 presents a circular or keyed profile that may align with a keyed anti-rotation feature on the device-side head coupler so that angular misalignment may be constrained when the head is seated. In other aspects, the ferrule coupler (removable) 610 could also include bayonet tabs, a shallow spline, or a threaded collar in embodiments where a mechanical detent or thread-on attachment is used instead of a magnetic quick-connect.

In several aspects, a hemispherical filament bundle 620 may extend from a distal throat of the head module and may provide a broad stroking envelope under slow rotation. The hemispherical filament bundle 620 may be formed by packing filament sub-bundles into a hemispherical shell, by arranging filaments around a dome-shaped puck, or by trimming a conical bundle to a hemispherical profile so that tip density may be higher near the centerline while remaining compliant at the periphery. In certain aspects, the hemispherical filament bundle 620 may be centered on the ferrule coupler (removable) 610 axis so that dynamic balance may be maintained when the head is rotated at slow commanded speeds.

In many aspects, the head module body 630 may retain the hemispherical filament bundle 620 using adhesive potting, a crimp sleeve, a compression collet, or a threaded retainer. The head module body 630 may define a throat geometry that manages near-root bending and may cooperate with an internal or external stiffness-tuning boundary, although such a boundary is optional in this figure. In some implementations, the head module body 630 may include vent slots or weep paths so that wash water may not remain trapped at the filament root after cleaning.

In some aspects, filament material variants 640 may represent alternative materials and geometries usable in the hemispherical filament bundle 620. The filament material variants 640 may include medical-grade silicone having a Shore hardness in a range of 00-20 to A-10, nylon 6 or nylon 12 monofilaments, or feather-analog microfibers, and may be washable and replaceable. Preferably, the filament material variants 640 may be selected to tune compliance, damping, and acoustic rustle so that slow-rotational stroking may feel gentle at low normal forces. In other aspects, the filament material variants 640 may include tapered filaments, dual-durometer filaments, or micro-textured tips to vary perceived breadth at a given contact force, for instance.

In various aspects, the hemispherical filament bundle 620 may be dimensioned to align with region-specific presets executed by a controller elsewhere in the system. The hemispherical filament bundle 620 may be realized at different filament lengths (e.g., 20 mm, 35 mm, or 50 mm in distinct heads) so that a shorter bundle may present a compact stroking footprint for scalp use while a longer bundle may present a wider footprint for back use. In some implementations, the hemispherical filament bundle 620 may mix two or more lengths within a single head to produce layered cues at low rotational speeds.

In several aspects, the ferrule coupler (removable) 610 may optionally incorporate a passive identifier to support service or sanitation workflows. The ferrule coupler (removable) 610 may accept a magnetically readable feature, a resistive ID, or an optical mark that a service jig may read during provisioning. In other aspects, a head presence detection threshold may be achieved by selecting a ferromagnetic counterface thickness that produces a target magnetic field magnitude when seated on a device-side magnet, allowing a controller to inhibit rotation upon absence of the head module body 630.

In certain aspects, the head module body 630 may be designed for institutional use and may include color-coding, engraved icons, or molded indicia to indicate stiffness class or region intent. The head module body 630 may be formed of autoclavable material in some variants, and the hemispherical filament bundle 620 may be realized as a removable filament module that may be replaced after a predefined number of cleaning cycles. Preferably, the head module body 630 and the hemispherical filament bundle 620 may maintain dimensional stability so that concentricity and balance may remain within runout limits when mounted to a head coupler.

In many aspects, manufacturing of the overall alternative head 600 may employ fixtures that ensure concentric assembly. The ferrule coupler (removable) 610 may be held in a collet while the hemispherical filament bundle 620 is placed and bonded, and a gauge mandrel may be used to set dome radius and tip spread prior to cure. The head module body 630 may then be dynamically evaluated on a spin fixture to verify that runout and balance may meet a threshold associated with slow-rotational operation. In other aspects, inspection may include pull-out testing of filament sub-bundles, visual inspection of potting fill, and measurement of the proximal throat diameter that influences near-root stiffness.

In some aspects, the overall alternative head 600 may be adapted to different coupling strategies without redesigning filament architecture. The ferrule coupler (removable) 610 may accept a swappable proximal insert so that, for example, a magnetic quick-connect interface may be used in one configuration while a bayonet-indexed insert may be used in another, with the hemispherical filament bundle 620 remaining common. In various aspects, this modularity may allow head kit offerings that support multiple device revisions while keeping tactile performance consistent.

In several aspects, the hemispherical filament bundle 620 may be configured to cooperate with a controller's presets for lull, drift, and coast. The hemispherical filament bundle 620 may produce a stable stroking envelope at constant speeds, may follow a sinusoidal modulation without chatter at the root, and may accept soft-start/soft-stop ramps without sudden deformation. In other aspects, the filament material variants 640 may be mapped to preset sets so that a silicone-based head may be paired with a particular ramp rate while a nylon-based head may be paired with a slightly different modulation amplitude.

In certain aspects, sanitation and durability of the overall alternative head 600 may be supported by material and feature choices. The head module body 630 may include corrosion-resistant finishes and radiused edges to minimize residue accumulation. The hemispherical filament bundle 620 may be wash-compatible, and the filament material variants 640 may include antimicrobial additives when institutional sanitation standards are desired. Preferably, the ferrule coupler (removable) 610 may avoid crevices at the proximal face so that a flat-to-flat seat against a device wear plate may be wiped clean rapidly, for instance.

In many aspects, the mass distribution of the overall alternative head 600 may be selected to maintain low moment of inertia while providing sufficient axial reaction at the proximal seat. The head module body 630 may concentrate mass near the axis to reduce off-axis torque during contact, and the ferrule coupler (removable) 610 may position any ferromagnetic counterface near the seat to keep axial stack height short. In other aspects, the hemispherical filament bundle 620 may present high compliance at the distal region so that light lateral forces do not substantially disturb concentric rotation.

In some aspects, kits may include several instances of the overall alternative head 600 differentiated by the filament material variants 640 and by color or symbol coding on the head module body 630. The kits may be matched to region-specific presets stored by a controller so that end users may select a head assembly aligned to a given application. In other aspects, documentation may include care instructions listing compatible cleaning agents for the filament material variants 640 and maximum cleaning temperatures for autoclavable versions.

In various aspects, the geometry of the ferrule coupler (removable) 610 and the head module body 630 may be dimensioned to cooperate with a keyed anti-rotation feature when present on a device-side coupler. The ferrule coupler (removable) 610 may include a shallow flat or spline that engages a mating key to prevent gradual angular drift during sweep motions, and the head module body 630 may provide a shoulder seat that reacts lateral loads without excessive wear on the mating wear/registration plate. In other aspects, the keyed feature may be replaced by a shallow detent pattern that indexes angular position at several positions while still permitting tool-less removal.

In several aspects, the hemispherical filament bundle 620 may be factory-balanced by selective trimming at the periphery or by rearranging sub-bundles inside the head module body 630. The goal may be to reduce runout to within a specified limit at the head coupler when rotated at low commanded speeds. Preferably, the filament material variants 640 may be supplied with manufacturing tolerances that enable repeatable balance outcomes across batches, for instance.

In certain aspects, the overall alternative head 600 thus may provide a removable, interchangeable head attachable to the head coupler that includes the ferrule coupler (removable) 610, the hemispherical filament bundle 620, the head module body 630, and the filament material variants 640. These structures may cooperate with a controller elsewhere in the system that regulates a rotational drive based on a rotational-speed signal to maintain a commanded low rotational speed as a non-vibratory slow-rotational stroking profile, while permitting head swaps that tailor tactile character without requiring changes to the underlying electronics or housing.

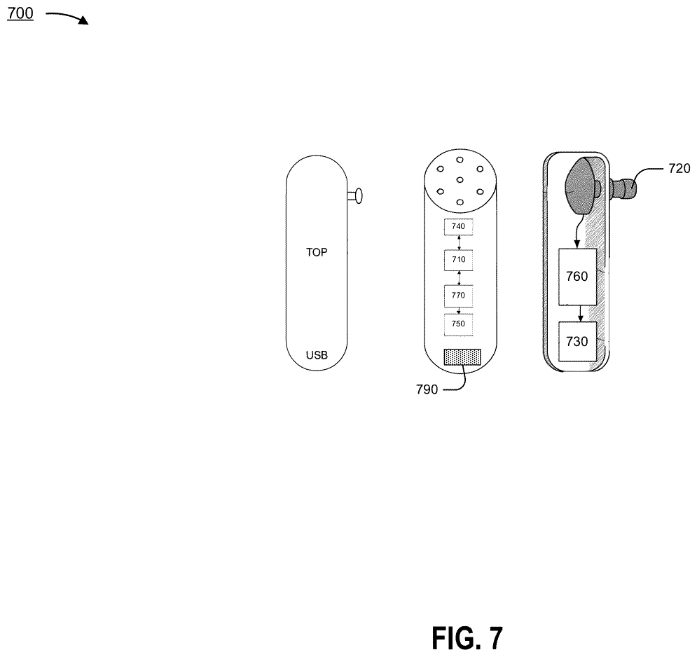

Referring to FIG. 7, which illustrates an overall electrical/control schematic 700 for a handheld tactile-stimulation system, the diagram may depict how electronic subsystems cooperate to regulate a rotational drive based on a rotational-speed signal to maintain a commanded low rotational speed as set forth in the disclosure. It shall be appreciated that other embodiments may reorganize functional blocks, may distribute logic into separate integrated circuits, or may integrate multiple blocks into a single system-on-chip while providing substantially similar behavior.

In some aspects, a controller (MCU) 710 may execute embedded firmware stored in a non-volatile memory (NVM) 750 to implement closed-loop regulation of a rotational drive. The controller (MCU) 710 may include one or more processing cores, timer/counter peripherals, analog-to-digital converters, pulse-width modulation generators, and serial interfaces. The controller (MCU) 710 may couple over an internal bus to the non-volatile memory (NVM) 750 for persistent storage of preset parameters, calibration tables, and safety thresholds, and the controller (MCU) 710 may also read a rotational-speed signal from a rotation sensor 720 to determine an actual rotational speed of a head coupler in real time. In various aspects, the controller (MCU) 710 may further read a motor-current signal produced by a current-sense circuit 730 and a temperature signal produced by a temperature sensor 740 to implement load management and thermal protection.

In certain aspects, the rotation sensor 720 may include a Hall-effect device sensing a two-pole magnet mechanically coupled to the head coupler so that each revolution may produce a pair of pulses counted by firmware to compute rotational speed. In other aspects, the rotation sensor 720 may include an incremental magnetic encoder, an optical interrupter disk, or a back-EMF estimator implemented by the controller (MCU) 710 during commutation dead-time sampling. The rotation sensor 720 may provide a digital pulse train, a quadrature signal, or an analog waveform that the controller (MCU) 710 may condition through timer capture units or ADC channels. Preferably, the rotation sensor 720 may be positioned to reduce wobble-induced jitter so that speed measurement fidelity may improve under light filament contact loads, for instance.

In several aspects, the current-sense circuit 730 may include a low-side shunt resistor and a differential amplifier that generates a motor-current signal proportional to armature current of a direct-current motor. In other aspects, the current-sense circuit 730 may include an inline Hall sensor, a high-side current monitor, or a sigma-delta current sensor integrated with a motor driver stage. The controller (MCU) 710 may sample the motor-current signal periodically to infer a contact-force condition at filament tips using a calibration curve stored in the non-volatile memory (NVM) 750. The current-sense circuit 730 may, in some aspects, also support stall detection by recognizing sustained current elevation at near-zero rotational speed inferred from the rotation sensor 720.

In many aspects, the temperature sensor 740 may include an NTC thermistor placed near a motor driver integrated circuit or near the motor winding region so that temperature rise may be correlated with joule losses under sustained load. In other aspects, the temperature sensor 740 may be a silicon bandgap sensor or a digital temperature sensor. The controller (MCU) 710 may read the temperature signal and may apply a thermal derating curve such that a commanded rotational speed may be reduced, or motor drive may be disabled, when a defined temperature threshold is exceeded to protect internal components and user safety.

In some aspects, a non-volatile memory (NVM) 750 may include serial flash or EEPROM that stores calibration parameters, such as a commanded-speed-to-PWM-duty lookup adjusted for a speed-reduction train, a mapping between motor current and inferred contact force, a magnet pull-force acceptance range for a magnetic quick-connect interface, and preset definitions that a user may select. The controller (MCU) 710 may persist session metadata into the non-volatile memory (NVM) 750, such as duration and preset identifier, and may optionally log inferred contact-force statistics that may later be retrieved through a service interface.

In various aspects, a PWM generator/driver 760 may generate a pulse-width modulation (PWM) motor drive signal that energizes the rotational drive at a carrier frequency above an audible range so that switching artifacts may be perceptually minimized. The PWM generator/driver 760 may be implemented as a discrete high-side/low-side driver controlling a full H-bridge for a brushed DC motor, an integrated half-bridge driver for a single-direction gearmotor, or a three-phase driver if a brushless motor is used. The PWM generator/driver 760 may accept a duty-cycle command from the controller (MCU) 710 and may expose diagnostic signals indicating over-current, under-voltage lockout, or thermal shutdown that the controller (MCU) 710 may monitor.

In certain aspects, preset/lock/timer logic 770 may reside as firmware modules executing on the controller (MCU) 710 and may manage user-selectable routines, a child-lock state, and a session auto-off timer. In some embodiments, the preset/lock/timer logic 770 may store and execute a plurality of presets including a lull preset having a ramped speed trajectory between approximately 35 and 55 revolutions per minute, a drift preset having a sinusoidal modulation about a nominal speed, and a coast preset having a substantially constant speed, each preset definition being persisted in the non-volatile memory (NVM) 750 with fields for start speed, end speed, ramp duration, sinusoid amplitude and period (for drift), and steady target speed (for coast). Preferably, the controller (MCU) 710 may retrieve the selected preset structure from the non-volatile memory (NVM) 750, validate a checksum, and arm a scheduler that updates a commanded low rotational speed according to the stored trajectory parameters to ensure deterministic execution under timer interrupts.

The preset/lock/timer logic 770 may implement a lull preset having a ramped speed trajectory between specified lower and upper rotational speeds, a drift preset having a sinusoidal modulation about a nominal speed, and a coast preset maintaining a substantially constant speed. The preset/lock/timer logic 770 may enforce a lockout until a defined user input sequence is detected at a user control, and may terminate drive after a preset session duration to promote consistent use patterns. In some implementations, the preset/lock/timer logic 770 may also rate-limit duty-cycle changes to reduce audible artifacts or mechanical jerk during soft-start and soft-stop.

In other aspects, a USB-C/charging port 790 may provide a physical interface for battery charging and service communications. The USB-C/charging port 790 may couple to battery management/charging so that cell protection, charge-current control, and balancing (for multi-cell packs) may be handled according to device chemistry. The USB-C/charging port 790 may also expose a service mode by which provisioning equipment may write firmware images and calibration parameters to the non-volatile memory (NVM) 750 and may read quality-control data after calibration. In some implementations, the USB-C/charging port 790 may support only charging and wired service, and may omit any live operational control during normal use.

In several aspects, battery management/charging may condition power from the USB-C/charging port 790 and may provide protected rails to the controller (MCU) 710, the PWM generator/driver 760, and sensor front-ends. Battery management/charging may include a fuel-gauge function that estimates state-of-charge, and the controller (MCU) 710 may use that estimate to limit a maximum commanded speed or to shorten a session duration when reserve capacity falls below a threshold. The battery management/charging may include protections for over-current, over-voltage, and over-temperature, and may signal status flags to the controller (MCU) 710 for coordinated derating.

In certain aspects, an operational flow may begin when a user actuates a push-rotary knob or other user control that signals the controller (MCU) 710 to exit a deep-sleep state. The preset/lock/timer logic 770 may determine whether a child-lock state is active and may request an enable sequence before the PWM generator/driver 760 is permitted to energize the rotational drive. The controller (MCU) 710 may then load a selected preset from the non-volatile memory (NVM) 750 and may initialize a commanded low rotational speed for the preset's opening segment. The controller (MCU) 710 may start a soft-start ramp so that the duty-cycle command issued to the PWM generator/driver 760 increases over time until the measured rotational speed from the rotation sensor 720 approaches a setpoint.

In some aspects, during steady operation, the controller (MCU) 710 may execute a closed-loop control algorithm that compares the rotational-speed signal against the setpoint and may adjust the duty-cycle command to maintain speed within a tolerance band, for example. The controller (MCU) 710 may concurrently sample the motor-current signal to infer a contact-force condition using the calibration curve stored in the non-volatile memory (NVM) 750 and may reduce the duty-cycle command when an inferred force threshold is exceeded to promote gentle tactile contact. The temperature sensor 740 may be sampled at a slower cadence; if a temperature threshold is exceeded, the controller (MCU) 710 may derate or disable the PWM generator/driver 760 until the temperature recovers to a safe operating range.

In various aspects, the controller (MCU) 710 may implement error handling by detecting a missing or invalid rotational-speed signal from the rotation sensor 720 and by detecting an abnormal current signature from the current-sense circuit 730. The controller (MCU) 710 may also verify head presence by monitoring an auxiliary magnetic field magnitude or by reading a head identifier through optional contacts (not shown in FIG. 7). Upon fault detection, the controller (MCU) 710 may command the PWM generator/driver 760 to zero duty cycle and may record a fault code to the non-volatile memory (NVM) 750.

In several aspects, preset/lock/timer logic 770 may schedule time-varying setpoints for lull, drift, and coast patterns. The lull preset may include a ramp profile that increases or decreases the commanded low rotational speed between lower and upper values over a defined interval. The drift preset may superimpose a sinusoidal modulation on a baseline speed so that perceived dynamics may remain subtle. The coast preset may maintain a substantially constant speed, which may support users who prefer steady tactile profiles. Session timing may be tracked by the preset/lock/timer logic 770 so that the PWM generator/driver 760 may be disabled after a session duration elapses.

In other aspects, calibration parameters resident in the non-volatile memory (NVM) 750 may be written during a provisioning process performed on a fixture. The commanded-speed-to-PWM-duty lookup may be derived by measuring actual speed under known loads so that the controller (MCU) 710 may start each preset segment with a near-correct duty-cycle seed value. The mapping between motor current and inferred contact force may be similarly produced by measuring current at known filament-tip forces so that the controller (MCU) 710 may estimate contact force in operation. A magnet pull-force acceptance range may be recorded so that maintenance personnel may verify retention characteristics during service.

In some implementations, firmware architecture executing on the controller (MCU) 710 may be partitioned into tasks, such as a control task running at a fixed interval that performs speed estimation and duty-cycle computation, an I/O task polling or interrupt-servicing the rotation sensor 720 and current-sense circuit 730, a thermal management task sampling the temperature sensor 740, and a preset task implementing time-varying patterns and session timing within preset/lock/timer logic 770. The control task may use fixed-point arithmetic for deterministic execution on a resource-constrained microcontroller, while the I/O task may use DMA transfers to reduce CPU load.

In certain aspects, the PWM generator/driver 760 may be commanded at an inaudible carrier frequency, and a rate-of-change limiter may cap duty-cycle slew so that audible noise may be suppressed. The controller (MCU) 710 may also monitor battery voltage from battery management/charging to perform brownout avoidance by limiting duty cycle when supply voltage drops under load. The USB-C/charging port 790 may provide a debug serial channel in a protected factory mode so that diagnostics, including commanded speed error under load and measured runout (if a sensor is present), may be captured during quality control.

In other aspects, the schematic 700 may be integrated with optional features discussed elsewhere, such as a magnetic quick-connect interface that may mechanically couple an interchangeable head to the head coupler, a push-rotary user control that may provide ON/OFF enable and speed selection, and a housing that may be sized for single-hand grasp and may provide splash resistance. While such mechanical items may not be shown in FIG. 7, their electrical relationships may be represented by inputs to the controller (MCU) 710 and by outputs from the PWM generator/driver 760 that energize the rotational drive.

In many aspects, the overall electrical schematic 700 may therefore provide an implementation pattern by which a sensor configured to produce a rotational-speed signal may inform a controller configured to regulate a rotational drive so that a commanded low rotational speed may be maintained. The coordination among the rotation sensor 720, the current-sense circuit 730, the temperature sensor 740, the non-volatile memory (NVM) 750, the PWM generator/driver 760, the preset/lock/timer logic 770, the battery management/charging, and the USB-C/charging port 790 may form a closed-loop embedded control system supporting gentle, non-vibratory slow-rotational stroking using interchangeable heads as described throughout this disclosure.

Referring to FIG. 8, which illustrates an overall magnetic interface 800 for coupling a removable, interchangeable head to a head coupler of a handheld tactile-stimulation system, the figure may depict a separable assembly oriented along a common axis so that a user may attach and detach a head module without tools. It shall be appreciated that other embodiments may implement alternative coupling mechanics that may include bayonet, threaded, or kinematic detent couplers while providing substantially similar coaxial alignment for slow-rotational stroking.

In some aspects, a magnetic quick-connect interface (device side) 810 may be positioned at a distal nose of a housing that includes a rotational drive, a head coupler, and electronics described elsewhere. The magnetic quick-connect interface (device side) 810 may define a generally circular coupling face with a centered recess or boss sized to receive a complementary feature of a head ferrule. The magnetic quick-connect interface (device side) 810 may be mechanically referenced to the head coupler so that axial seating of a head results in a predictable axial standoff and concentricity during rotation at commanded low rotational speed, for example.

In various aspects, a ferromagnetic counterface (head side) 820 may be disposed at a proximal end of a removable head ferrule so that the ferromagnetic counterface (head side) 820 may be attracted toward the magnetic quick-connect interface (device side) 810. The ferromagnetic counterface (head side) 820 may be formed of stainless steel, low-carbon steel, or other magnetically responsive alloy that may also serve as a wear surface bonded to the ferrule body. Preferably, the ferromagnetic counterface (head side) 820 may present a flat or slightly crowned face to promote repeatable seating and to distribute contact pressure over a wear surface, for instance.

In certain aspects, a permanent-magnet element 830 may be embedded on the device side or the head side to supply axial retention. The permanent-magnet element 830 may include a rare-earth magnet (e.g., NdFeB ring or disk) with a nickel or epoxy coating, and the permanent-magnet element 830 may be bonded into a counterbore so that a magnetic field may couple through the ferromagnetic counterface (head side) 820 when the components are brought into proximity. The permanent-magnet element 830 may be selected to provide an axial pull force in an acceptance range suitable for tool-less removal while resisting shear during gentle skin contact. In other aspects, a multi-pole magnet pattern may be used to improve centering and reduce sliding during alignment.

In several aspects, a keyed anti-rotation feature 840 may be incorporated to constrain relative angular misalignment between the interchangeable head and the head coupler. The keyed anti-rotation feature 840 may be realized as a shallow spline, a D-flat, radially spaced nubs interfacing with corresponding pockets, or an indexed notch that engages upon axial seating. The keyed anti-rotation feature 840 may reduce slip under lateral loading at filament tips so that commanded rotational speed may remain consistent when the head experiences light contact forces. In alternative embodiments, the keyed anti-rotation feature 840 may be replaced with a frictional detent pattern, a wave spring interface, or a kinematic tri-lobe that may provide discrete angular indexes for repeatable head orientation.

In many aspects, a standoff boss 850 may extend from the device nose to establish an axial offset between the housing skin and a rotating ferrule/filament envelope. The standoff boss 850 may function as a registration shoulder that reacts lateral loads to the housing structure and may provide a guard that spaces flexible filaments from the main enclosure. The standoff boss 850 may also center the head during attachment by guiding the ferromagnetic counterface (head side) 820 into contact. Preferably, the standoff boss 850 may be machined or molded with a controlled diameter tolerance so that radial runout at the seated head may be limited to a predefined value, for instance.

In other aspects, a wear surface/plate may be provided at the magnetic quick-connect interface (device side) 810 to resist galling and to preserve flatness after repeated head swaps. The wear surface/plate may be formed of stainless steel or anodized aluminum with a low-friction finish, and the wear surface/plate may be adhesively bonded or mechanically retained with a press fit. The wear surface/plate may also serve as an electrical shield in embodiments where optional contacts are placed off-axis for head identification or sanitation sensing, although electrical contacts are not required. In some implementations, the wear surface/plate may include micro-texture to vent air during seating so that a vacuum adhesion effect may be minimized.

In certain aspects, the overall magnetic interface 800 may be designed so that an operator aligns a head module along the axis of the standoff boss 850 and advances the head until the ferromagnetic counterface (head side) 820 meets the wear surface/plate. At proximity, the permanent-magnet element 830 may draw the head into full contact, and the keyed anti-rotation feature 840 may engage to establish angular orientation. Upon completion of seating, the head ferrule may be axially located by the standoff boss 850 and may be rotationally constrained by the keyed anti-rotation feature 840, permitting the rotational drive to rotate the head coupler with low runout. Removal may be accomplished by an axial pull that exceeds the magnetic retention threshold, after which the head may be cleaned or replaced.

In some aspects, surface coatings used within the overall magnetic interface 800 may include nickel-copper-nickel on the permanent-magnet element 830 to resist corrosion, hard-anodize on the wear surface/plate to reduce scratching, and a low-friction polymeric overcoat to reduce squeak during micro-slip. Adhesives used to retain the permanent-magnet element 830 may include structural epoxies that may withstand sanitation chemicals, and the ferromagnetic counterface (head side) 820 may be bonded using a primer-activated acrylic that may tolerate repeated thermal cycling. Dimensional stack-up of the standoff boss 850, keyed anti-rotation feature 840, and wear surface/plate may be controlled to maintain total indicated runout at or below a predefined limit so that a non-vibratory slow-rotational stroking profile may be preserved during operation.

In various aspects, alternative embodiments of the overall magnetic interface 800 may include a bayonet quarter-turn mechanism supplemented by a weaker permanent-magnet element 830 so that tactile indexing may be pronounced, or a threaded micro-collet so that head modules may be locked for applications requiring higher shear resistance. In these cases, the keyed anti-rotation feature 840 may be reinterpreted as a bayonet lug pair or a thread start index, and the ferromagnetic counterface (head side) 820 may be retained primarily for seating flatness rather than for axial force. The standoff boss 850 may remain as a datum for axial spacing in such alternatives.

In several aspects, tolerances for the overall magnetic interface 800 may be defined so that contact flatness between the ferromagnetic counterface (head side) 820 and the wear surface/plate may be within a small planarity window. The magnetic retention supplied by the permanent-magnet element 830 may be specified to overcome friction and minor off-axis loads while allowing removal by a typical user with a steady axial pull. The keyed anti-rotation feature 840 may be specified to limit angular lash that could otherwise produce low-frequency wobble or tick during rotation. The standoff boss 850 may be designed with a small lead-in chamfer so that misaligned head insertion may be guided into concentricity without edge damage.

In other aspects, the overall magnetic interface 800 may accommodate optional sensing features that the controller described elsewhere may use for diagnostics or presets. For instance, the permanent-magnet element 830 may produce a magnetic field magnitude that may be sensed by a hall element positioned behind the magnetic quick-connect interface (device side) 810 so that head presence may be detected and rotation may be inhibited upon absence. The ferromagnetic counterface (head side) 820 may optionally include a secondary identifier feature such as a small resistive or magnetic code element placed off-axis that may be read by a corresponding reader; however, such identification is optional and may be omitted to maintain simplicity.

In many aspects, materials and finishes selected for components of the overall magnetic interface 800 may support sanitation. The ferromagnetic counterface (head side) 820 and the wear surface/plate may be smooth to a low surface roughness so that residue may be readily wiped. The standoff boss 850 may be contoured to avoid fluid traps, and the magnetic quick-connect interface (device side) 810 may include a slight drainage slope so that cleaning fluids may not pool. The permanent-magnet element 830 may be sealed with a thin edge fillet of adhesive to reduce crevice accumulation. In alternative medical-or institutional-grade configurations, the ferromagnetic counterface (head side) 820 may be part of an autoclavable carrier attached to a removable filament module.

In certain aspects, the mechanical integration between the overall magnetic interface 800 and the rotational drive may include a coupler shaft supported by bearings located behind the magnetic quick-connect interface (device side) 810. The keyed anti-rotation feature 840 may be mechanically referenced to that shaft so that torque may be transferred through a low-compliance path. The standoff boss 850 may be formed as part of a nose sub-frame that anchors the bearing seats, and the wear surface/plate may be fastened to that sub-frame to provide a rigid datum for the ferromagnetic counterface (head side) 820. Preferably, this integration may assist in limiting runout and maintaining a commanded low rotational speed without inducing vibratory artifacts, for instance.

In several aspects, assembly of the overall magnetic interface 800 may be performed by first bonding the permanent-magnet element 830 into a counterbore in the magnetic quick-connect interface (device side) 810, installing the wear surface/plate over the magnet with a non-magnetic spacer, verifying pull force with a calibrated force gauge, and then pressing or fastening the standoff boss 850 and keyed anti-rotation feature 840 subcomponents into the nose structure. The head subassembly may be completed by bonding the ferromagnetic counterface (head side) 820 into a ferrule carrier and verifying flatness. The finished parts may be gauged for pull force and angular lash to verify compliance with design windows.

In other aspects, the overall magnetic interface 800 may cooperate with a controller described elsewhere so that presets may be safely executed only when a head is present. A user may perform head swaps between head variants, each having different filament materials or lengths, and the coupling geometry may provide a repeatable axial seat regardless of head type. The keyed anti-rotation feature 840 may preserve angular orientation so that any asymmetrical filament flare may be consistently presented to a user. The standoff boss 850 may preserve clearance from the housing during operation, and the wear surface/plate may maintain seating quality over repeated cycles.

In many aspects, this figure may therefore depict how the magnetic quick-connect interface (device side) 810, the ferromagnetic counterface (head side) 820, the permanent-magnet element 830, the keyed anti-rotation feature 840, the standoff boss 850, and the wear surface/plate may be arranged to enable tool-less, repeatable, and hygienic attachment of interchangeable heads. The arrangement may support slow-rotational stroking profiles by preserving concentricity and by resisting unintended slippage during gentle skin contact, while allowing rapid head changes to adapt tactile profiles for different regions or sanitation protocols. Transitioning from this coupling detail, a reader may refer to the operational depiction that may illustrate a dynamic stroking envelope and to the electrical/control schematic that may show closed-loop regulation during use. n some aspects, quantitative specifications of the overall magnetic interface 800 may be provided as exemplary ranges to assist manufacturing and quality control. The permanent-magnet element 830 may have an outer diameter between approximately 6 mm and 14 mm, a thickness between approximately 1 mm and 4 mm, and a remanence Br that may be selected from approximately 1.1-1.4 T, while a nominal air-gap at final seating between the permanent-magnet element 830 and the ferromagnetic counterface (head side) 820 may be less than approximately 0.05 mm due to the wear surface/plate establishing a hard stop. Magnetic retention force Fm may be estimated under first-order assumptions as Fm≈(B^2·A)/(2·μ0), where B may denote flux density at the interface, A may denote effective pole area, and μ0 may denote permeability of free space, noting that real assemblies may deviate due to fringing and surface flatness. Preferably, surface flatness of the ferromagnetic counterface (head side) 820 and the wear surface/plate may be held within approximately 0.03 mm over the seating diameter to promote repeatable pull force and to reduce wobble during rotation, for instance.

In various aspects, signal interactions with electronics described in the schematic may be supported by the overall magnetic interface 800. A hall sensor (not shown in FIG. 8) located behind the magnetic quick-connect interface (device side) 810 may measure a field magnitude that rises above a presence threshold when the ferromagnetic counterface (head side) 820 is seated. The controller described elsewhere may sample that sensor via an ADC or GPIO interrupt and may inhibit rotational drive if the presence threshold is not met. Optionally, a secondary identifier element embedded near the ferromagnetic counterface (head side) 820 may be read via a resistive or magnetic signature that a service tool may query over the USB-C/charging port described elsewhere using a simple register protocol; however, such identification may be omitted to maintain simplicity.

In certain aspects, tribological and corrosion behaviors of mating surfaces may be addressed. The wear surface/plate may include a hard-anodized aluminum coating with a thickness in a range of approximately 20-50 μm or a hardened stainless plate with surface roughness Ra≤0.8 μm. The ferromagnetic counterface (head side) 820 may include a passivated finish, and edges on the standoff boss 850 may include a 0.2-0.5 mm lead-in chamfer that may guide insertion and reduce edge wear. Adhesive bonds retaining the permanent-magnet element 830 may be specified for shear strength ≥10 MPa and peel strength ≥2 MPa at 23° C., with a safety factor applied for elevated temperature and cleaning solvent exposure.

In several aspects, configuration variability may be supported without compromising interchangeability. The ferromagnetic counterface (head side) 820 may be circular, faceted, or include shallow radial slots that may allow air bleed during seating. The keyed anti-rotation feature 840 may utilize one, two, or three shallow splines; increasing spline count may reduce angular lash at the expense of tolerance sensitivity. The standoff boss 850 may be integral to a polymer nose insert or may be a metallic sub-frame press-fit into the housing; the latter may improve stiffness and may reduce runout growth under thermal cycling. The permanent-magnet element 830 may be on the device side as illustrated, but in alternative heads the magnet may be placed on the head and the device may define the ferromagnetic counterface (device side), with the wear surface/plate remaining as the seating datum.

In many aspects, software routines may be aligned to the mechanics of the overall magnetic interface 800. Upon detection of head presence via the field magnitude measurement, a head-attach debounce timer may be started, and the controller may wait for a quiet period before permitting motor enable. A sanitation counter stored in non-volatile memory may be incremented upon each attach event inferred from transitions of the field magnitude, and presets may be gated when a threshold count is reached until a user acknowledgement is received, for example. The controller may also map detected head class (if identification is implemented) to allowed preset menus so that user selection may be filtered to head-appropriate RPM trajectories.

In other aspects, interactions with dynamic balance may be considered. The keyed anti-rotation feature 840 may be referenced to the rotational axis such that an eccentricity vector associated with the head mass distribution may be repeatedly oriented relative to the coupler. In provisioning, balance correction of the head may be performed with reference to that orientation so that runout and imbalance may remain within tolerance when the head is reattached. Such orientation fidelity may be verified by a simple optical index mark on the head ferrule aligned with the keyed anti-rotation feature 840.

In certain aspects, hygienic and environmental conditions may guide detailed geometry. The standoff boss 850 may include a drainage slope of approximately 1-2 degrees toward the outer edge so that cleaning fluids may run off instead of pooling near the permanent-magnet element 830. The wear surface/plate may be bonded with a closed-edge fillet that may minimize capillary ingress of fluids. Elastomeric gaskets at the interface periphery may be omitted to keep the surface easily wipeable, while the internal nose structure may rely on labyrinths and internal seals to meet splash resistance targets.

In several aspects, assembly and inspection procedures may be outlined to reinforce industrial applicability. A magnetization step may be performed after bonding the permanent-magnet element 830 to avoid local heating during magnetization. A force-displacement curve may be measured during head attachment on a production test jig to confirm that the capture distance, pull-in, and final retention meet defined windows. A shear test with a lateral load applied at the ferrule shoulder may be used to estimate resistance to off-axis sliding with the keyed anti-rotation feature 840 engaged.

In many aspects, safety considerations may be addressed. A maximum allowable pinch force at the seating interface may be estimated by combining magnet retention and user pull speed; edge radii on the ferromagnetic counterface (head side) 820 and the wear surface/plate may be selected to keep contact pressures below thresholds during inadvertent finger placement. The permanent-magnet element 830 may be recessed below the wear surface/plate plane to reduce direct user contact with magnet coatings that may flake under abuse.

In other aspects, industry-specific adaptations may be contemplated. For spa or clinical environments, the ferromagnetic counterface (head side) 820 may be integrated with an autoclavable carrier, while the main head filaments may be a removable module that may be replaced between users. For consumer environments, the keyed anti-rotation feature 840 may be simplified to reduce manufacturing cost while maintaining sufficient angular registration for the slow-rotational profile.

In certain aspects, standards and protocols may be cited as informative references for materials and finishes, such as ASTM A967 for stainless passivation and ASTM D3359 for coating adhesion. Dimensional tolerances for the standoff boss 850 diameter and concentricity relative to the coupler axis may be held to ISO 2768-mK or a comparable standard suitable for molded or machined parts.

In several aspects, the overall magnetic interface 800 may also cooperate with future figures that may detail calibration and testing sequences. n many aspects, a lifecycle analysis may be considered. Accelerated life testing may cycle the head attachment thousands of times while monitoring changes in pull force and angular lash. The wear surface/plate may be inspected for surface degradation, and the adhesive bond of the permanent-magnet element 830 may be checked for creep. Measured drift may be logged in a device record during quality control so that trend analysis may be performed across production lots.

In other aspects, a modular product strategy may leverage the common overall magnetic interface 800 across a family of heads having different ferrule geometries. The ferromagnetic counterface (head side) 820 seating diameter may be standardized, while head-specific sub-features may vary to tune tactile profiles. This approach may allow manufacturing to supply an interchangeable head kit while maintaining consistent coupling mechanics and electronics behaviors across models. In some aspects, the controller may execute a closed-loop regulation algorithm that may be expressed step-by-step so that a person of ordinary skill can implement it on typical embedded hardware. A representative speed-control routine may include: (1) sampling a rotational-speed signal ωm[n] from a rotation sensor at a fixed control interval Ts (e.g., 1-5 ms); (2) computing a speed error e[n]=ωcmd[n]−ωm[n], where ωcmd[n] may be a commanded low rotational speed derived from a preset; (3) transforming the error through a compensator, which may be a proportional-integral (PI) controller uPI[n]=KP·e[n]+KI·Σe[n], with anti-windup implemented by clamping Σe[n] when a duty limit is hit; (4) blending uPI[n] with a calibrated duty feed-forward uFF[n] obtained by looking up a commanded-speed-to-PWM-duty value DFF(ωcmd) stored in non-volatile memory; (5) applying safety modifiers including a torque/force limiter that scales duty according to motor current I[n] via a table F(I) so that u[n]=sat{α·uPI[n]+(1−α)·uFF[n]}·F(I), where 0≤α≤1 and sat{·} bounds the signal; and (6) outputting u[n] to a PWM generator at a carrier frequency above 20 kHz while enforcing a rate-of-change limit du/dt to reduce audible artifacts. The algorithm may further include soft-start/soft-stop ramp generators that may constrain dωcmd/dt to predefined slopes to mitigate mechanical jerk at the filaments.

In other aspects, the mapping between motor current and inferred contact force may be produced during provisioning by loading the filaments with known tip forces and recording (ω, I) pairs while sweeping speed. A calibration curve \hat{F}=g(ω, I) may be computed using polynomial regression or a two-dimensional table with bilinear interpolation; this curve may be stored as a compact grid (e.g., 8×8 nodes) in non-volatile memory along with scale/offset metadata. At runtime, the controller may compute an inferred contact-force condition F\hat{F}[n]=g(ωm[n], I[n]) and may compare \hat{F}[n] to thresholds Tsoft and Thard to decide whether to reduce duty, hold speed, or stop rotation. Preferably, a hysteresis band may be used to avoid chatter around thresholds.

In several aspects, data structures may be defined to satisfy persistence, diagnostics, and service-mode requirements. A parameter block may include: header with version and CRC32; preset table entries each containing nominal speed, trajectory type (ramp, sinusoid, constant), duration, and ramp slopes; feed-forward duty table DFF(ω) sampled at uniform speed breakpoints; force-inference grid nodes with row/column scales; thermal derating curve points mapping internal temperature to allowable duty multipliers; sanitation counters; child-lock configuration; and magnet pull-force acceptance range. A session log ring buffer may record for each session: preset ID, start time, duration, average speed error, maximum inferred force, and fault codes. A service protocol over the USB-C interface may expose read/write of the parameter block and read-only session logs using a simple request/response frame with an 8-bit command, 16-bit length, payload, and CRC, although other wired protocols may be used.

In certain aspects, the sensor configured to produce a rotational-speed signal may be a Hall sensor paired with a two-pole magnet on the head coupler. Period measurement τ between rising edges may be converted to speed by ωm=60/(Np·τ), with Np indicating pulses per revolution (e.g., Np=2). A digital filter, such as an IIR single-pole low-pass with coefficient a=exp(−Ts/τf) where τf may be a smoothing constant (e.g., 50 -150 ms), may be applied to suppress quantization and jitter. For brushless implementations, back-EMF zero-crossing timing may be used in place of discrete sensors. The algorithm may be unsuitable for mental performance due to the high-rate sampling, fixed-point arithmetic, timer capture, and PWM generation that must execute deterministically within sub-millisecond deadlines under asynchronous interrupts.

In many aspects, the rotational drive may include a gearmotor sized to deliver sufficient stall torque at commanded low speeds. A brushed coreless DC motor with a 30:1 to 60:1 planetary reduction may be used as one example, where nominal operating speed under load may be 30-100 RPM at the head. Bearings supporting the head coupler may include a pair of miniature ball bearings spaced along the axis to increase stiffness; axial preload may be set by a wave spring. Dynamic balance may be achieved by adding small mass trims to the ferrule or by selective assembly, and total indicated runout at the coupler may be maintained ≤0.25 mm during operation by controlling concentricity and perpendicularity of the seating stack (nose frame, wear plate, ferrule).

In other aspects, the housing may be manufactured from PC-ABS with a TPE overmold at grip regions; internal bosses may locate the motor, controller PCB, and nose sub-frame. Splash resistance at least to IPX4 may be provided by gasketed seams and a sealed USB-C receptacle. A tether anchor may be molded into the rear wall for institutional anti-loss compliance. The interchangeable head may be detached and washed in water with mild detergent; materials may be selected for chemical resistance to common sanitizers.

In several aspects, the user control may be a push-rotary encoder with tactile detents that do not impart vibration to the head. A short press may toggle enable, a long-press sequence may satisfy child-lock, and rotation may adjust preset selection or continuous speed depending on mode. The controller may debounce input, interpret events through a finite-state machine, and update indicators such as a tri-color LED that may show state-of-charge and lock status.

In certain aspects, the non-vibratory slow-rotational stroking profile may be defined as a motion regime in which the primary energy is in steady angular rotation with low angular acceleration magnitudes, without superimposed ultrasonic or acoustic-pressure components, without optical or medicament subsystems. This operational regime may improve tactile consistency by avoiding percussive impulses and may reduce user sensitivity to high-frequency noise; the technical improvement may be achieved by combining closed-loop low-speed regulation, calibrated duty feed-forward, and force-responsive derating that adapts to contact loads in real time.

In many aspects, the overall process may not be practically performed in a human mind because it may require high-rate sampling and control computation, precise PWM generation at ultrasonic carriers, and multi-signal fusion across speed, current, and temperature sensors with deterministic timing constraints. Embedded execution may further manage safety interlocks, sanitation gating, and persistent logging, all of which may rely on machine-timed events and hardware peripherals.

In other aspects, industrial applicability may include consumer wellness, spas, sensory rooms, and sleep labs. A facility may deploy multiple units with standardized coupling geometries; heads may be color-coded by stiffness; sanitation logs may be downloaded via wired service during audits. During manufacturing, a provisioning fixture may measure pull force, runout, and RPM accuracy under a 20-gram tip load, then write calibration parameters and presets to memory, ensuring that production variability is absorbed and that the device maintains ±5% speed accuracy in use. It shall be noted that the coupling geometry of the overall magnetic interface 800 may be tuned to achieve a predictable rotational stroking envelope by controlling the parallelism between the ferromagnetic counterface (head side) 820 and the wear surface/plate 860, and by defining a repeatable datum on the standoff boss 850 that may limit tilt under off-axis loading. In some embodiments, the keyed anti-rotation feature 840 may be dimensioned with an angular clearance of approximately 0.5-1.5 degrees so that micro-misalignments may not translate into perceivable wobble at the filaments, while still permitting easy tool-less removal. As illustrated in FIG. 8, the permanent-magnet element 830 may be placed concentrically within the magnetic quick-connect interface (device side) 810 to minimize radial bias forces during seating; alternatively, a dual-magnet layout may be used to counterbalance fringing fields when the ferromagnetic counterface (head side) 820 includes apertures for air bleed.

It shall be noted that the overall magnetic interface 800 may be used across a variety of industry and technological domains where hygienic, fast-swap end-effectors may be advantageous. In some embodiments, environments may include consumer wellness and relaxation products, spa and clinical sensory-room deployments, sleep laboratories, occupational therapy centers, and controlled airport lounge environments.

In some embodiments, the design may yield technical benefits over conventional threaded or purely friction-fit couplers. Firstly, unlike conventional techniques that solely rely on thread engagement with multiple turns, the magnetic quick-connect interface (device side) 810 may provide near-instant axial capture that may reduce handling time, while the keyed anti-rotation feature 840 may limit angular lash without requiring torque-on or torque-off maneuvers that may fatigue users. Secondly, in some embodiments, the wear surface/plate 860 may decouple seating flatness from magnet coating durability, which may reduce surface degradation and sustain consistent pull force across many attachment cycles. Thirdly, in certain aspects, the standoff boss 850 may maintain clearance between rotating filaments and the housing skin so that wipe-down cleaning may be performed without disassembling the nose structure.

It shall be noted that signal-level interactions associated with the coupling may extend beyond head presence. In some embodiments, a hall sensor located behind the magnetic quick-connect interface (device side) 810 may provide an analog field magnitude that may be digitized and mapped to inferred seating quality by the controller described elsewhere; for example, a magnitude below a soft threshold may indicate partial seating, prompting an audible or LED indication to reseat the head. In other embodiments, a passive identifier incorporated into or adjacent the ferromagnetic counterface (head side) 820 may be read by an inductive or magnetic signature reader to select presets appropriate to filament stiffness, although such identification may be optional.

In some embodiments, additional tolerancing guidance may be provided to maintain low runout during operation. As illustrated in FIG. 8, concentricity between the standoff boss 850 and the rotation axis may be held to ≤0.05 mm, and parallelism between the wear surface/plate 860 and a bearing reference shoulder may be held to ≤0.03 mm. Surface hardness of the wear surface/plate 860 may be at least 400 HV for anodized aluminum or Rockwell C≥40 for stainless steel to improve wear resistance under repeated seating and micro-slip events.

It shall be noted that multiple modular configurations may be supported without redesigning the nose. In some embodiments, the permanent-magnet element 830 may be moved to the head, with the device defining the ferromagnetic seat; the keyed anti-rotation feature 840 may remain shared so that legacy heads may still be used. In other embodiments, a bayonet-assist variant may introduce a shallow quarter-turn motion that may increase resistance to shear while the magnet maintains axial preload; this variant may be particularly suited for mobile or transport use where jostling may occur.

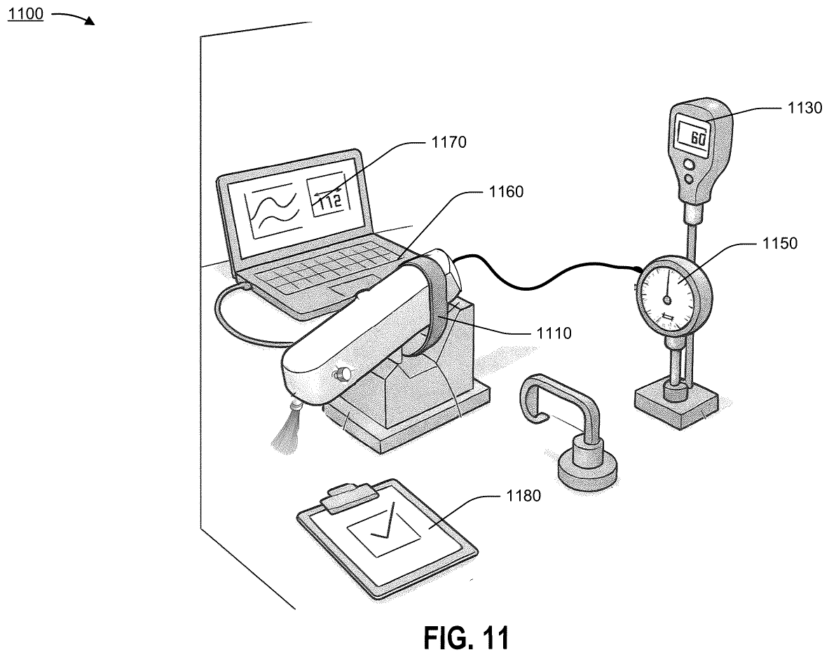

In some embodiments, field maintenance and lifecycle procedures may be defined to preserve performance. A cleaning schedule may specify wiping the wear surface / plate 860 with isopropyl alcohol and checking the magnetic quick-connect interface (device side) 810 for debris that may compromise seating. A service check may measure retention force using a handheld gauge; results may be logged in a device record and compared with the acceptance range established during provisioning (see FIG. 11). For institutional settings, heads may be rotated through an autoclavable carrier workflow while the device remains on a wipe-down protocol.

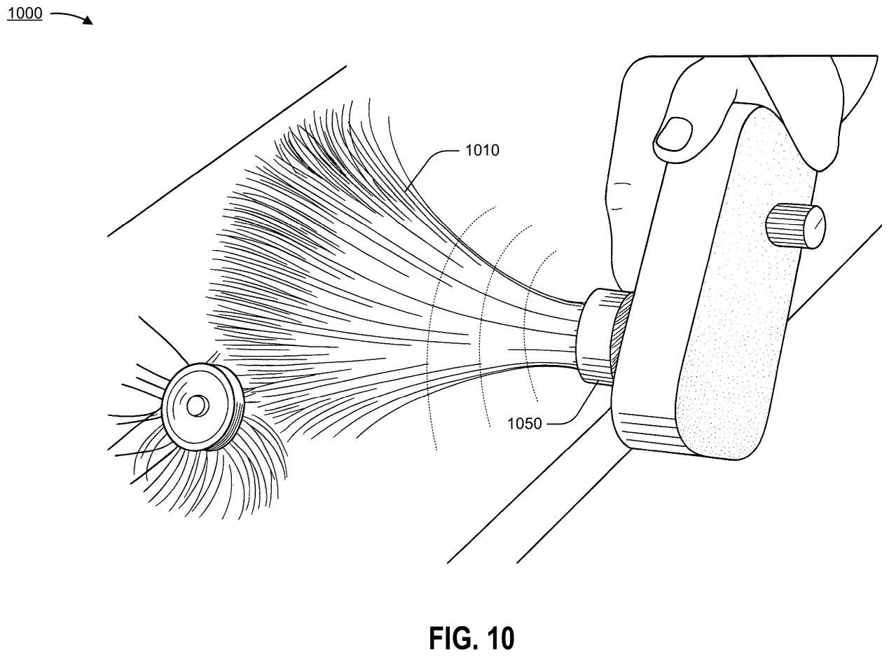

It shall be noted that the benefits may be quantifiable in user-centric trials. Firstly, unlike conventional threaded couplers that may vary in final axial position due to thread tolerance and user torque, the combination of the wear surface/plate 860 and the ferromagnetic counterface (head side) 820 may yield a fixed axial datum, which may improve consistency of the rotational stroking envelope shown in FIG. 10. Secondly, in some embodiments, the keyed anti-rotation feature 840 may enable repeatable angular orientation of asymmetrical filament arrays, which may allow presets tuned to directional stroking to be perceived more consistently across sessions. Thirdly, the standoff boss 850 may reduce the risk of filament fouling against the housing edge during sweeping motions, which may result in fewer unplanned stalls and smoother low-speed regulation.

As illustrated in FIG. 8, additional mechanical safeguards may be integrated without altering the coupling fundamentals. In some embodiments, a small axial relief groove around the permanent-magnet element 830 may act as a debris trap that may be cleaned periodically. In other embodiments, the ferromagnetic counterface (head side) 820 may include a thin polymeric over-ring that may seal the interface against liquid ingress during rinse cycles while maintaining metal-to-metal seating on the wear surface/plate 860.

It shall be noted that these details may reinforce industrial applicability by enabling tool-less, repeatable head interchange that may preserve concentricity and reduce operator fatigue, while providing measurable quality-control checkpoints.

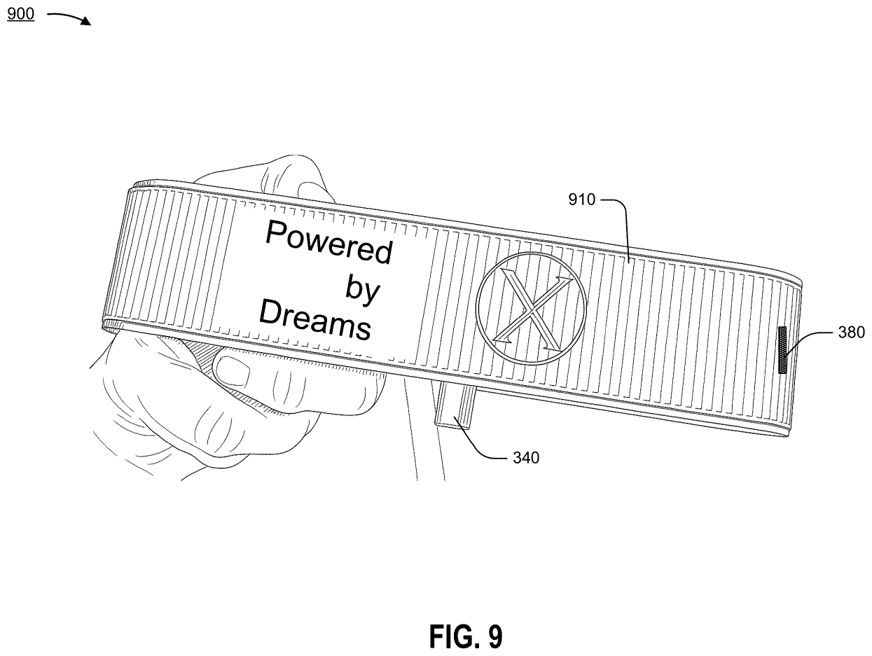

Referring to FIG. 9, which illustrates an exterior perspective view of a handheld tactile-stimulation system, an exterior enclosure body 910 may provide the “housing” that, in some aspects, may contain a power source disposed within the housing, a rotational drive configured to rotate a head coupler, a sensor configured to produce a rotational-speed signal, and a controller configured to regulate the rotational drive to maintain a commanded low rotational speed. It shall be appreciated that other embodiments may utilize a differently contoured enclosure, different surface textures, or different port placements while still implementing a handheld tactile-stimulation system as generally described herein.

In some aspects, the exterior enclosure body 910 may define an elongated, radiused form factor sized for single-hand grasp, with a continuous outer shell that may include internal bosses, ribs, and rails that support internal subassemblies such as printed circuit boards, mounting plates, and the rotational drive shafting, even though such internal features are not visible in this figure. The exterior enclosure body 910 may be formed as a two-piece molded shell joined along a seam that may be sealed with an elastomeric gasket or overmold to support splash resistance, for example. The exterior enclosure body 910 may be fabricated of PC-ABS, ABS, or other structural thermoplastics, and in several aspects may include at least 30 percent recycled plastic content by mass to support sustainability objectives without constraining strength targets, for instance. The exterior enclosure body 910 may provide sufficient wall thickness around the nose region (not visible here) to support a head coupler and bearing alignment and may include an interior boss pattern around a sidewall to reinforce the connector region associated with a port described below.

In various aspects, a USB port 380 may be integrated as a charging/service interface accessible at a sidewall penetration of the exterior enclosure body 910. The USB port 380 may be a USB-C receptacle that may support both power delivery and a wired service mode for provisioning and diagnostics; in other embodiments a barrel-type DC jack or a 3.5 mm TRS-style connector may be substituted, while the USB port 380 nomenclature may still be used to denote the service/charging role. The USB port 380 may be mounted by a panel nut, snap clip, or flange with threaded hardware, and may be backed by strain relief and board-to-port cabling that routes to charging and battery-management circuitry inside the housing, for example. The USB port 380 may be encircled by a compressible gasket or O-ring that interfaces to an outer flange of the receptacle to mitigate liquid ingress during wipe-down sanitation. In some aspects, the USB port 380 may be oriented to favor cable strain relief that routes away from the stroking end of the device, thereby reducing the chance of cable interference with user manipulation during charging or servicing.

In certain aspects, a power/adjustable speed control module switch 340 may be positioned at a region of the exterior enclosure body 910 accessible to a user's thumb or index finger when the device is held in a natural grasp. The power/adjustable speed control module switch 340 may be implemented as a push-rotary knob that provides an ON/OFF enable (for example, via press-to-toggle or press-and-hold to engage a child-lock sequence) and continuous speed selection through a rotational motion, although other user interface elements such as a linear slider, a multi-position detent switch, or capacitive touch controls may also be used. Preferably, the power/adjustable speed control module switch 340 includes tactile detents that are generated locally in the control but are mechanically isolated from the rotational drive so that the detent sensation does not impart vibration to an interchangeable head during operation. The power/adjustable speed control module switch 340 may route its signals to the controller within the housing to select a commanded low rotational speed and to invoke presets such as a lull preset, a drift preset, or a coast preset, as defined elsewhere in this description.

In several aspects, the exterior enclosure body 910 may include a gently flattened area that may serve as a benchtop resting surface to stabilize the device when not in use. The exterior enclosure body 910 may further include subtle surface textures, micro-ribbing, or overmolded elastomer zones that may improve grip, although such textures may not be visible at the scale of this figure. In some aspects, ergonomic curvature of the exterior enclosure body 910 may be aligned with the center of mass of the internal battery and rotational drive so that the device may be balanced in a user's hand when the interchangeable head is installed at the nose region (not shown in this figure), thereby facilitating smooth arcs and linear sweeps along a target skin surface.

In other aspects, while the rotational drive, the head coupler, the removable, interchangeable head, and the sensor configured to produce a rotational-speed signal are internal or located at the distal nose and are therefore not visible in this exterior perspective, their relationship to the exterior enclosure body 910 may be described textually. The rotational drive may be secured on internal mounts aligned to a longitudinal axis of the exterior enclosure body 910, the head coupler may be supported by a nose bearing stack registered to the housing's interior bosses, and the sensor configured to produce a rotational-speed signal may be mounted proximate to the head coupler or motor shaft to generate a rotational-speed signal that the controller may read to regulate the commanded low rotational speed. The removable, interchangeable head may be seated at a circular nose interface with a shoulder that may abut an exterior nose boss region of the exterior enclosure body 910; such nose features may be shown in other figures and may be understood to be present even when not depicted here.

In many aspects, the USB port 380 may cooperate with manufacturing fixtures to implement provisioning steps. The USB port 380 may convey firmware images and calibration parameters into non-volatile memory within the housing, which may enable the controller to execute closed-loop regulation during operation without requiring an external application for live control, for example. The USB port 380 may also expose a service mode in which session metadata such as preset identifier, duration, and inferred contact-force statistics may be read for quality assurance or field returns analytics, although such telemetry features may be optional and may be disabled for consumer privacy policies. In several aspects, the USB port 380 may negotiate a charging profile appropriate for a rechargeable power source inside the housing, and may provide over-voltage, over-current, and reverse-polarity protections implemented by an internal battery-management subsystem.

In some aspects, the power/adjustable speed control module switch 340 may be logically coupled to a preset/lock/timer logic that may provide a session auto-off timer, a child-lock, and preset selection. For instance, a press-and-hold gesture on the power/adjustable speed control module switch 340 may unlock rotation, whereas a shorter press may toggle between preset routines, and a rotational movement may fine-tune a commanded speed within a preset's allowed band. The physical placement of the power/adjustable speed control module switch 340 on the exterior enclosure body 910 may be selected so that a user may actuate controls while maintaining contact of the interchangeable head with skin, thereby enabling continuous, gentle stroking trajectories during preset transitions.

In various aspects, thermal and ingress considerations may be implemented in the exterior enclosure body 910 and USB port 380 region. The wall thickness around the USB port 380 may be increased to provide a flat seating land for a gasket under a panel flange, and the exterior enclosure body 910 may include a molded lip that may engage with a mating recess on a connector body to deflect wipe-down liquids away from the port aperture. Internally, a metalized insert or heat spreader may be bonded or screwed beneath a motor driver or charging IC location and may couple into the exterior enclosure body 910 to distribute heat during fast charging or continuous operation. Preferably, these features may reduce case temperature rise while maintaining user comfort, for example.

In several aspects, visual indicators or legends may be included proximate to the power/adjustable speed control module switch 340 and USB port 380 to assist accessibility. A tri-color indicator pattern may be placed near the power/adjustable speed control module switch 340 to indicate battery state-of-charge thresholds or lock state, and high-contrast icons may be printed or etched near the USB port 380 to denote service/charging orientation. In some implementations, tactile features, such as a shallow groove or raised dot, may be integrated at the power/adjustable speed control module switch 340 to signal detent positions and assist operation in low-light environments.

In some aspects, the exterior enclosure body 910 may optionally include a tether anchor or lanyard eyelet on a distal sidewall for facility anti-loss or anti-drop compliance. Such an anchor may be molded as a reinforced loop or may be provided as a metal insert captured between shell halves. When present, the anchor may be positioned so that a tether does not interfere with the user's grip or with the stroking path of the interchangeable head.

In other aspects, the mechanical integration of the USB port 380 may consider cabling and harness routing within the housing defined by the exterior enclosure body 910. A short, shielded pigtail may link the USB port 380 to a primary control printed circuit board, with strain relief features molded into the inner wall. The exterior enclosure body 910 may include cable clips that may route the harness away from the rotational drive region to avoid entanglement risks and to maintain airflow around heat-dissipating components. Preferably, the cable bend radius near the USB port 380 may remain within manufacturer specifications to preserve long-term reliability, for instance.

In various aspects, the exterior enclosure body 910 may be finished using processes that may improve cleanability and durability. A light texture or matte coating may resist fingerprints while remaining easy to sanitize with alcohol-based wipes. If branding or orientation marks are included on the exterior enclosure body 910, such marks may be recessed or embossed to act as tactile cues without interfering with wipe-down procedures. In one example, a recessed panel may be centered on a sidewall to receive a logo or regulatory text, while internal ribs continue behind the panel to maintain stiffness.

In certain aspects, the exterior enclosure body 910 may be designed for assembly and serviceability. Fastener bosses and snap features may be placed at regions away from the USB port 380 to avoid stress concentrations around the connector cutout. The seam line may be positioned along a neutral bending axis to reduce panel gaps under grip loads. Internal features may be designed so that the housing may be disassembled in six or fewer fastener-removal steps, facilitating repair, battery replacement, or head coupler service, while maintaining structural integrity during typical use.

In some aspects, electromagnetic compatibility may be considered around the USB port 380 penetration region. A conductive gasket or shield can may be integrated behind the USB port 380 to reduce emissions and enhance immunity, while maintaining isolation from user-accessible metal surfaces. The exterior enclosure body 910 may include ground lugs or bosses for attaching shields with consistent pressure. These measures may be optional but may assist compliance with consumer device standards.

In several aspects, the controller located within the housing defined by the exterior enclosure body 910 may regulate the rotational drive during operation, while the FIG. 9 perspective emphasizes how external surfaces and interfaces may support that regulation. For example, the power/adjustable speed control module switch 340 may signal a commanded low rotational speed, the controller may read a rotational-speed signal from an internal sensor, and the controller may adjust motor drive to maintain the commanded speed. The USB port 380 may not be involved during normal operation, but may be utilized before or after sessions to transfer presets, calibration parameters, or logs in a wired service mode.

In other aspects, manufacturing tolerances at the USB port 380 cutout and the mating flange may be specified such that a connector may remain square to the wall, thus preventing undue stress on a cable and preserving the environmental seal with the exterior enclosure body 910. If a barrel-type connector is substituted, the exterior enclosure body 910 may employ a slightly different counterbore and shoulder design while still maintaining ingress management and mechanical retention.

In many aspects, FIG. 9 may illustrate how the exterior industrial design and port placement of the handheld tactile-stimulation system may contribute to usability, sanitation, and serviceability without constraining internal architecture. The exterior enclosure body 910 may support an internal power source disposed within the housing, a rotational drive configured to rotate a head coupler, a sensor configured to produce a rotational-speed signal, and a controller configured to regulate the rotational drive, even though such components are not shown in this view. The USB port 380 may provide a charging/service path, and the power/adjustable speed control module switch 340 may provide a user interface for ON/OFF enable, speed selection, and preset invocation. Building upon the aforementioned structures, subsequent figures may show the nose interface, magnetic quick-connect head engagement, and internal control elements that, together with the surfaces presented in FIG. 9, may implement a non-vibratory slow-rotational stroking profile suitable for gentle tactile stimulation.

Referring to FIG. 10, which illustrates an overall operation view 1000 of a handheld tactile-stimulation system in active use, the device may be shown executing a non-vibratory slow-rotational stroking profile under closed-loop control. It shall be appreciated that other embodiments may present a different grip orientation or background environment while preserving the functional arrangement of the handheld tactile-stimulation system depicted by the overall operation view 1000.

In some aspects, FIG. 10 visually communicates the outcome of a controller configured to regulate a rotational drive based on a rotational-speed signal to maintain a commanded low rotational speed. The visible effect may be depicted as a dynamic filament envelope 1010 that flares into a fan-shaped region during rotation. The dynamic filament envelope 1010 may represent a time-integrated sweep of flexible filaments of an interchangeable head attachable to a head coupler, where the filaments may follow a substantially circular trajectory at low angular velocity rather than a reciprocating or percussive path. In some implementations, the dynamic filament envelope 1010 may appear wider at distal regions and more coherent near a root region, which may correlate to a gentle-contact condition in which centrifugal effects slightly splay the filaments while the controller maintains speed using feedback from a sensor configured to produce a rotational-speed signal.

In various aspects, the coupler alignment shoulder 1050 may be visible at the interface between the device nose and the removable, interchangeable head. The coupler alignment shoulder 1050 may provide an annular reaction face that may seat the ferrule of the interchangeable head against a registration surface of the head coupler to assist in maintaining concentricity during rotation. Preferably, the coupler alignment shoulder 1050 includes a low-friction or wear-resistant finish so that, during repeated head swaps and during off-axis stroking, the head may remain axially registered without appreciable galling, for example. In some embodiments, the coupler alignment shoulder 1050 may cooperate with an internal keyed feature and/or a magnetic quick-connect interface that may act together to constrain angular misalignment while allowing tool-less removal, as shown by way of example in other figures.

In certain aspects, the overall operation view 1000 may demonstrate how the controller may hold the commanded low rotational speed while the user performs arcs, lines, or spiral trajectories over a target surface. As the interchangeable head sweeps across the target, the sensor configured to produce a rotational-speed signal may generate pulses or encoder ticks, and the controller may adjust motor drive to offset minor load changes. This feedback behavior may stabilize the apparent curvature and density of the dynamic filament envelope 1010 so that perceived stroking remains consistent despite variations in contact pressure or local surface geometry.

In some aspects, the device depicted by the overall operation view 1000 may include a housing that may support ergonomic grasp, a power source disposed within the housing, the rotational drive configured to rotate the head coupler, and the removable, interchangeable head. Although most internal elements are not visible in FIG. 10, the operational appearance of the dynamic filament envelope 1010 may indicate that a speed command has been received from a user control (for instance, a push-rotary knob described elsewhere), and that the closed-loop control may be active to track that command. In several implementations, soft-start and soft-stop ramp profiles may be applied by the controller so that changes in speed may transition smoothly, which may be inferred visually by a lack of abrupt changes in the dynamic filament envelope 1010 when the user starts, stops, or changes presets.

In other aspects, the dynamic filament envelope 1010 may encode, in a single still image, a variety of optional presets. For instance, a lull preset may gradually ramp between lower and slightly higher speeds, and on a long-exposure depiction this may appear as a gentle thickening or thinning of the dynamic filament envelope 1010 over time. A drift preset may sinusoidally modulate speed about a nominal value, which may yield a faint ripple effect in the apparent blur spacing if captured during the modulation cycle. A coast preset may hold a substantially constant speed, resulting in a uniform and symmetric dynamic filament envelope 1010. Although such time-varying nuances may not be resolved in a single drawing, the figure may be understood to be consistent with any of these operational modes.

In several aspects, the coupler alignment shoulder 1050 may be dimensioned to cooperate with dynamic balance targets so that runout at the head coupler may remain within a limit during operation at commanded speed. The coupler alignment shoulder 1050 may abut a ferrule shoulder of the interchangeable head and may thereby stabilize the axis of rotation even when an operator lightly contacts uneven surfaces. Preferably, this alignment may reduce unintended lateral motion at filament roots and may help maintain a non-vibratory appearance in the dynamic filament envelope 1010. The coupler alignment shoulder 1050 may also serve as a tactile cue to an operator installing the head; when the head is fully seated, a subtle stop may be felt as the ferrule shoulder reaches the coupler alignment shoulder 1050.

In some implementations, the overall operation view 1000 may also suggest a relationship between contact force and speed regulation. During gentle contact with skin, the rotational drive may experience a slight torque increase. The sensor configured to produce a rotational-speed signal may detect a small decrease in speed, and the controller may responsively increase motor drive to maintain the commanded low rotational speed. If a motor-current-derived contact-force inference is employed in firmware, the system may optionally reduce duty cycle when a threshold is exceeded, thereby narrowing the dynamic filament envelope 1010 to indicate a lighter contact condition. Although these internal signals are not shown in FIG. 10, the effect may be reflected in the envelope's width and uniformity.

In various aspects, the dynamic filament envelope 1010 may reflect an interchangeable head selected from a kit with different filament materials, diameters, and lengths. For example, a silicone filament set may generate a relatively smooth envelope with a soft edge, a nylon filament set may form a slightly crisper edge, and a feather-analog bundle may produce an even softer silhouette. The selection of head may also affect the local stiffness near the ferrule, which may be influenced by a proximal stiffness-tuning structure; under rotation, a stiffer proximal section may keep the envelope narrower near the root and more flared distally. The figure may be interpreted to support any such head variant used with the device.

In certain embodiments, the coupler alignment shoulder 1050 may be integral to a wear/registration plate and may operate together with a standoff boss located within the nose region (as shown in other drawings). This stack may set axial spacing for the filaments relative to the housing and may help the operator approach curved body contours without the shell contacting the surface. Preferably, the coupler alignment shoulder 1050 may be formed of stainless steel, anodized aluminum, or a low-friction polymer insert to extend service life. The shoulder may be flush with or slightly recessed from the head ferrule face to discourage debris collection at the interface.

In some aspects, the overall operation view 1000 may provide context for accessibility features. A controller may provide a reduced-torque mode that caps a maximum commanded rotational speed and limits a rate-of-change of duty cycle, which may make the dynamic filament envelope 1010 more stable and predictable for sensitive users. Audible or visual indicators may optionally provide a user feedback indication when an inferred contact-force value exceeds a threshold; when such events occur, the envelope may visibly narrow as the controller reduces drive to maintain a gentle-contact profile.

In other aspects, hygiene and sanitation workflows may be inferred from the depiction. The operator may remove the interchangeable head after a session, wash the filaments, and reinstall the head until the ferrule shoulder seats against the coupler alignment shoulder 1050. A sanitation counter stored in non-volatile memory may increment on each head removal/attachment cycle, and preset execution may be gated if a sanitation acknowledgment is not received after a threshold number of cycles. While these operations are not explicitly shown in FIG. 10, the seating behavior about the coupler alignment shoulder 1050 may be understood to mediate repeatable mechanical alignment after each cleaning event.

In several implementations, noise characteristics may correlate with the quality of the dynamic filament envelope 1010. If runout increases or the head becomes unbalanced, the envelope may show subtle asymmetry or thickness variation. A controller may optionally limit audible noise by enforcing rotational speed limits or by applying duty-cycle smoothing, and these actions may restore the symmetry of the dynamic filament envelope 1010 during subsequent operation. Preferably, such measures may keep steady-state sound levels within desired thresholds at typical distances, for instance.

In some aspects, the overall operation view 1000 may also illustrate how a user may position the device to engage different regions of the body. As the operator transitions from a scalp region to a back region, the commanded speed may be adjusted using a user control to match a preset associated with the new region. The controller may then re-stabilize the low rotational speed, and the dynamic filament envelope 1010 may adapt in width accordingly. The coupler alignment shoulder 1050 may continue to maintain axial registration of the head during these transitions.

In many aspects, FIG. 10 may serve as a capstone depiction of runtime behavior, complementing internal schematics and coupling details shown elsewhere. The overall operation view 1000 may corroborate that the handheld tactile-stimulation system can produce a visibly smooth, low-speed rotary sweep at the filaments while the controller regulates rotational speed based on a rotational-speed signal. The dynamic filament envelope 1010 may provide a visual shorthand for the non-vibratory nature of the stroking, and the coupler alignment shoulder 1050 may illustrate a structural feature that may assist with mechanical registration, reduced wobble, and repeatable head seating.

Transitioning from the operational perspective of FIG. 10, subsequent calibration and provisioning figures may detail how speed accuracy under load, magnet pull force, and runout may be quantified and recorded before shipment, and earlier structure figures may be referenced as example embodiments of the components that cooperate to produce the runtime behavior shown by the overall operation view 1000.

Referring to FIG. 11, which illustrates an overall provisioning/calibration environment 1100 for preparing a handheld tactile-stimulation system for autonomous closed-loop operation, it shall be appreciated that other embodiments may rearrange or substitute stations while accomplishing substantially similar provisioning functions. In some aspects, the overall provisioning/calibration environment 1100 may include fixtures, gauges, programming interfaces, and recordkeeping elements that may cooperate to assemble, calibrate, verify, and document a handheld tactile-stimulation device prior to shipment, for example. Building upon the hardware and control structures discussed for the handheld system, FIG. 11 may focus on manufacturing and service-station processes that may generate calibration parameters, program firmware, verify mechanical and electrical characteristics, and produce quality-control records in support of the device's autonomous closed-loop regulation at commanded low rotational speeds.

In certain aspects, a provisioning fixture 1110 may be configured to secure a handheld device in a repeatable pose that aligns a head coupler and an interchangeable head relative to metrology tools. The provisioning fixture 1110 may include V-block supports, soft jaws, or conformal pads to constrain translation and rotation while avoiding cosmetic damage to a housing. The provisioning fixture 1110 may present datum features that register a nose portion and a rear portion such that a rotational axis of a rotational drive may be colinear with a load application axis for force and speed testing. The provisioning fixture 1110 may further include adjustable arms or telescoping bars that may set stand-off distances for optical tach pickup alignment and dial indicator placement, and the provisioning fixture 1110 may provide electrical pass-throughs or cable management paths to route a service cable from a charging/service interface to a programming station without interfering with gauges. In some aspects, the provisioning fixture 1110 may incorporate a safety interlock that may inhibit motor drive during head changes or when a guard is lifted, and the provisioning fixture 1110 may integrate a low-friction interface under a head region so that tip loads may be applied without undue shear.

In various aspects, a speed/tach readout 1130 may be configured to display or stream a measured rotational speed during calibration runs. The speed/tach readout 1130 may use an optical reflective sensor, a magnetic pickup, a laser tachometer, or a proximity sensor that may sense contrast marks or magnetic features coupled to a head ferrule or a coupler. The speed/tach readout 1130 may include a sampling module and a frequency-to-RPM conversion process that may average over multiple revolutions to reduce jitter. The speed/tach readout 1130 may provide a digital output that may be consumed by a calibration utility executing on the firmware programming station 1160 or by a separate data logger. Preferably, the speed/tach readout 1130 is positioned to avoid contact with flexible filaments while maintaining a stable line of sight or field coupling, for instance.

In some aspects, a runout measurement gauge 1150 may include a dial indicator, lever-type test indicator, or a displacement sensor that may contact a circular reference surface at a head coupler shoulder or a ferrule seat to quantify total indicated runout (TIR). The runout measurement gauge 1150 may be mounted on a magnetic base or a rigid arm attached to the provisioning fixture 1110, and the runout measurement gauge 1150 may be swept through 360 degrees while the head is slowly turned by hand or jogged under low duty cycle. The runout measurement gauge 1150 may output a peak-to-peak displacement value that may be compared to a limit value to support dynamic balancing and concentric seating. In some aspects, the runout measurement gauge 1150 may be used before and after head swaps to confirm repeatability of seating and to validate a keyed anti-rotation or indexed seating feature as optionally described elsewhere.

In several aspects, a firmware programming station 1160 may be a computing host connected to the device through a wired charging/service interface. The firmware programming station 1160 may load bootloader code and application firmware into a non-volatile memory and may subsequently write device-specific calibration parameters into an allocated data region. The firmware programming station 1160 may present a workflow that may guide an operator through a sequence including head installation, load application, speed measurement, current measurement, and parameter computation. The firmware programming station 1160 may additionally set default preset parameters such as a lull preset, a drift preset, and a coast preset, may enable a child-lock default state and a session auto-off parameter, and may set control loop gains or lookup entries that may map commanded rotational speed to an initial pulse-width modulation duty value. In other aspects, the firmware programming station 1160 may also write a PWM carrier frequency setpoint above an audible range and may record model identifiers, firmware versions, and manufacturing dates into a device record.

In many aspects, a calibration dataset 1170 may be generated by the firmware programming station 1160 during the calibration process. The calibration dataset 1170 may include a commanded-speed-to-PWM-duty mapping that may be produced by measuring rotational speed at multiple duty values under a plurality of known filament-tip loads. The calibration dataset 1170 may additionally include a mapping between motor current and inferred contact force, which may be constructed by applying known normal forces at filament tips and recording steady-state current at one or more commanded rotational speeds. The calibration dataset 1170 may further include a magnet pull-force acceptance range for embodiments with a magnetic quick-connect interface, a runout limit value, and preset configuration data such as soft-start and soft-stop ramps. The calibration dataset 1170 may be stored in the non-volatile memory of the device and may be mirrored to a manufacturing database for traceability. In some aspects, environmental corrections such as ambient temperature and humidity may be stored within the calibration dataset 1170 to assist subsequent interpretation of current-vs-force regression coefficients.

In certain aspects, a load application rig may be used to apply a plurality of known filament-tip loads to an installed interchangeable head. The load application rig may include calibrated weights, spring scales, or an instrumented force probe that may contact a distal region of flexible filaments at a controlled radial offset from a rotational axis. The load application rig may employ a low-friction tip, such as a PTFE pad, to minimize shear while loading normal force. The load application rig may incorporate spacers or stops to apply forces at repeatable radial distances for a consistent torque load. In some implementations, the load application rig may be automated by a linear actuator so that forces may be swept and held while speed and current are recorded into the calibration dataset 1170.

In other aspects, a magnet pull-force test jig may be configured to quantify axial retention force of a magnetic quick-connect interface in embodiments that include permanent-magnet seating. The magnet pull-force test jig may attach to a ferrule or head carrier and may apply an axial pull through a force gauge until separation occurs, at which point a peak pull value may be recorded. The magnet pull-force test jig may be used with several head variants to validate a pull-force acceptance window and to verify that a wear surface or registration plate remains dimensionally consistent after repeated cycles. The magnet pull-force test jig may be used prior to and after sanitation cycles to observe any changes in adhesion due to surface films, and measured values may be appended to the calibration dataset 1170 or to a QC record entry 1180.

In some aspects, a sanitation counter parameter may be initialized and stored in the non-volatile memory as part of provisioning. The sanitation counter parameter may be incremented whenever a head removal event and a head attachment event are detected by the device, such as by monitoring magnetic field magnitude or mechanical detent transitions. The sanitation counter parameter may be used by firmware to gate preset execution until an operator acknowledgment is received after a threshold number of head cycles, which may support institutional sanitation protocols. The sanitation counter parameter may be visible to a technician through the firmware programming station 1160 in a service mode for inspection and reset, if permitted by policy.

In several aspects, a QC record entry 1180 may be generated at the completion of the calibration and verification sequence. The QC record entry 1180 may include identifiers such as a device serial number, firmware version, and date/time stamps, and may store measured outcomes including commanded-speed accuracy under a known tip load, a magnet pull-force value, a runout value, and an acoustic noise metric if a microphone-based test is included. The QC record entry 1180 may be digitally signed or otherwise authenticated to support traceability and may be associated with a barcode or QR code applied to a packaging label. The QC record entry 1180 may further include a pass/fail outcome and may note any rework actions taken such as rebalancing a head or replacing a coupler.

In some aspects, the overall provisioning/calibration environment 1100 may be operated as a step-wise method that may align to labeled processes. As shown in a first process, the provisioning fixture 1110 may secure a handheld device and may present it for head installation and initial checks. As shown in a subsequent process, the load application rig may apply a first known filament-tip load and the speed/tach readout 1130 may report a rotational speed, which may be recorded by the firmware programming station 1160 to build the commanded-speed-to-PWM-duty mapping. As shown in a next process, a current measurement step may be performed while maintaining steady rotational speed under the applied load, which may be appended to a motor-current-vs-force dataset. As shown in another process, the magnet pull-force test jig may determine an axial retention value for a magnetic quick-connect interface and compare it to an acceptance range. As shown in an additional process, the runout measurement gauge 1150 may be swept to record a total indicated runout value for the seated head. As shown in a programming process, the firmware programming station 1160 may write firmware instructions, calibration parameters, preset parameters, and the sanitation counter parameter into non-volatile memory, and may set a PWM carrier frequency. As shown in a verification process, the device may be commanded to hold a nominal rotational speed, and the speed/tach readout 1130 may confirm tolerance under a known tip load. As shown in a concluding process, the QC record entry 1180 may be finalized and a device may be released for shipment.

In various aspects, relationships between stations may be configured to minimize operator burden and reduce error. For example, the speed/tach readout 1130 may stream data to the firmware programming station 1160 over a serial or USB link so that a calibration utility may automatically compute lookup tables and regression coefficients for the calibration dataset 1170. The runout measurement gauge 1150 may also be equipped with a digital probe that may push readings directly to the firmware programming station 1160 through a data capture interface. The magnet pull-force test jig may include a peak-hold indicator that may be photographed by a camera attached to the firmware programming station 1160 to automatically parse numeric values into a record. The sanitation counter parameter may be annotated in the QC record entry 1180 with an initial baseline and a policy threshold so that downstream servicing personnel may determine when sanitation acknowledgment is expected.

In some aspects, numeric targets recorded during provisioning may be treated as examples rather than limits. A speed-accuracy verification may be performed at a mid-range commanded speed and at a warm device temperature, but other verification conditions may be used. A runout limit may be expressed as a TIR threshold at the head coupler, but other balance metrics may be recorded, such as a balance grade at a nominal operating speed. An acoustic noise metric may be expressed as an A-weighted sound pressure level at a defined distance, but other acoustic criteria may be applied. The firmware programming station 1160 may apply derating curves based on a temperature sensor reading if a calibration sequence is performed at elevated ambient conditions.

In other aspects, the overall provisioning/calibration environment 1100 may support multiple interchangeable head variants. During calibration, a first head with a specified filament length and stiffness class may be installed to build a baseline commanded-speed-to-PWM-duty mapping. A second head with a different filament density may be used to refine a current-vs-force mapping or to create a head-specific offset that may be stored alongside the calibration dataset 1170. The magnet pull-force test jig may be repeated for each head to verify consistent retention. The runout measurement gauge 1150 may be used to assess concentricity repeatability across head changes, which may be noted in the QC record entry 1180 as a seating repeatability statistic.

In many aspects, the firmware programming station 1160 may also initialize user-facing safety and accessibility parameters. A child-lock default state may be enabled so that a device may require a defined input sequence before enabling rotation during first use. A session auto-off parameter may be set to a default duration and may be stored alongside preset parameters. A reduced-torque mode may be activated for devices assigned to pediatric or elder care environments, which may cap a maximum commanded rotational speed and rate-of-change of duty cycle. A deep-sleep state may be configured so that standby draw may remain below a target threshold after inactivity.

In certain aspects, the QC record entry 1180 may serve as an index to retrieve the calibration dataset 1170 and may be linked to a ledger entry or manufacturing database. The QC record entry 1180 may enable traceability for later service events such as head replacements, battery replacements, or firmware updates. The QC record entry 1180 may be updated in a service mode when a device is returned for maintenance and a new calibration or verification is performed, and the same provisioning fixture 1110 may be reused to repeat measurements for consistency.

In some implementations, the overall provisioning/calibration environment 1100 may be adapted to high-throughput lines by distributing the steps among multiple stations. A first station may perform head installation and initial runout measurement using the runout measurement gauge 1150. A second station may perform load-based speed and current collection using the load application rig and the speed/tach readout 1130. A third station may perform magnet pull-force verification using the magnet pull-force test jig. A fourth station may execute firmware writing and parameterization using the firmware programming station 1160. A fifth station may finalize the QC record entry 1180 and may print labels. Station-to-station handoff may be synchronized through barcodes or RFID tags such that data collected at each station may be appended to a common device record.

Transitioning from the provisioning context, subsequent figures may depict alternative mechanical coupler geometries or method flow diagrams that may expand on the programming and verification sequence summarized above. Preferably, the processes shown in FIG. 11 may provide repeatable calibration and documentation so that the handheld device may autonomously regulate a rotational drive based on a rotational-speed signal to maintain a commanded low rotational speed during end-use scenarios, for instance.

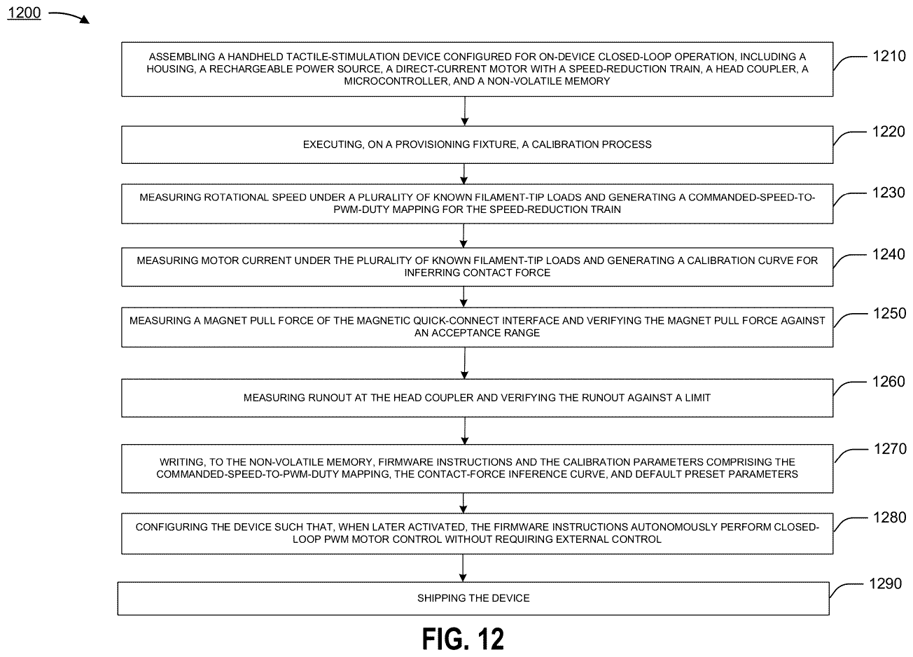

FIG. 12 is a flowchart of an example method for serving/manufacturing/hosting, the method including the following.

At step 1210, the method may include assembling a handheld tactile-stimulation device configured for on-device closed-loop operation, including a housing, a rechargeable power source, a direct-current motor with a speed-reduction train as a rotational drive, a head coupler, a microcontroller as a controller, and a non-volatile memory.

At step 1220, the method may include executing, on a provisioning fixture, a calibration process.

At step 1230, the method may include measuring rotational speed under a plurality of known filament-tip loads and generating a commanded-speed-to-PWM-duty mapping for the speed-reduction train.

At step 1240, the method may include measuring motor current under the plurality of known filament-tip loads and generating a calibration curve for inferring contact force.

At step 1250, the method may include measuring a magnet pull force of the magnetic quick-connect interface and verifying the magnet pull force against an acceptance range.

At step 1260, the method may include measuring runout at the head coupler and verifying the runout against a limit.

At step 1270, the method may include writing, to the non-volatile memory, firmware instructions and the calibration parameters comprising the commanded-speed-to-PWM-duty mapping, the contact-force inference curve, and default preset parameters.

At step 1280, the method may include configuring the device such that, when later activated, the firmware instructions autonomously perform closed-loop PWM motor control via a PWM generator/driver without requiring external control.

At step 1290, the method may include shipping the device.

### Conclusion

For clarity of explanation, the above description has focused on a representative sample of all possible embodiments, a sample that teaches the principles of the invention and conveys the best mode contemplated for carrying it out. The invention is not limited to the described embodiments. Well known features may not have been described in detail to avoid unnecessarily obscuring the principles relevant to the claimed invention. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed alternatives, variations, modifications, and equivalents are within the literal scope of the following claims, and others are equivalent. The claims may be practiced without some or all of the specific details described in the specification. In many cases, method steps described in this specification can be performed in different orders than that presented in this specification, or in parallel rather than sequentially, or in different computers of a computer network, rather than all on a single computer. It is to be understood that the present technology contemplates that, to the extent possible, one or more features of any implementation can be combined with one or more features of any other implementation.

While the above description details certain embodiments of the invention and describes the best mode contemplated, no matter how detailed the above appears in text, the invention can be practiced in many ways. Therefore, implementation details may vary considerably while still being encompassed by the invention disclosed herein. Particular terminology used when describing certain features or aspects of the invention should not be taken to imply that the terminology is being redefined herein to be restricted to any specific characteristics, features, or aspects of the invention with which that terminology is associated.

Any specific manifestations of these and other similar example processes are not intended to be limiting to the disclosure. Any suitable manifestation of these and other similar example processes can be selected within the scope of the illustrative embodiments.

Thus, a computer-implemented method, system or apparatus, and computer program product are provided in the illustrative embodiments for systems and methods for a handheld non-vibratory tactile-stimulation device with interchangeable filament heads and other related features, functions, or operations. Where an embodiment or a portion thereof is described with respect to a type of device, the computer-implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser, or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present disclosure may be a system, a method, and/or a computer program product at any possible technical detail level of integration. The computer program product may include a computer-readable storage medium (or media) having computer-readable program instructions thereon for causing a processor to carry out aspects of the present disclosure.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on a dedicated system or user's computer, partly on the user's computer or dedicated system as a stand-alone software package, partly on the user's computer and partly on a remote computer or entirely on the remote computer or server, etc. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

What is claimed is:

1. A handheld tactile-stimulation system comprising:
a housing;
a power source disposed within the housing;
a rotational drive configured to rotate a head coupler;
a removable, interchangeable head attachable to the head coupler;
a sensor configured to produce a rotational-speed signal; and
a controller configured to regulate the rotational drive based on the rotational-speed signal to maintain a commanded low rotational speed.

2. The system of claim 1, wherein the system further comprises a magnetic quick-connect interface (810), the magnetic quick-connect interface comprising a permanent-magnet element and a ferromagnetic counterface, and further comprising a keyed anti-rotation feature that constrains relative angular misalignment between the interchangeable head and the head coupler.

3. The system of claim 1, wherein the controller executes a closed-loop control algorithm to maintain a commanded rotational speed within plus or minus 5 percent of a setpoint under a 20-gram filament-tip load in a band of 30 to 100 revolutions per minute; and wherein a non-vibratory slow-rotational stroking profile omits ultrasonic actuation, acoustic-pressure vibration, optical stimulation, and medicament delivery.

4. The system of claim 1, wherein the controller generates a pulse-width modulation (PWM) drive signal via a PWM generator/driver at a PWM carrier frequency above 20 kilohertz.

5. The system of claim 1, wherein the interchangeable head comprises a ferrule that retains a plurality of filament sub-bundles and a proximal stiffness-tuning structure that increases bending stiffness near the ferrule while preserving distal compliance at filament tips.

6. The system of claim 1, wherein a flexible filament comprise one or more of medical-grade silicone having a Shore hardness in a range of 00-20 to A-10, nylon 6 or nylon 12 monofilaments, or feather-analog microfibers, each being washable and replaceable, and configured for gentle stroking contact against human skin.

7. The system of claim 1, wherein the controller stores and executes a plurality of presets including a lull preset having a ramped speed trajectory between 35 and 55 revolutions per minute, a drift preset having a sinusoidal modulation about a nominal speed, and a coast preset having a substantially constant speed.

8. The system of claim 1, wherein the controller enforces a session auto-off timer configured to terminate drive after a preset duration and further enforces a child-lock state requiring a defined user input sequence prior to enabling rotation.

9. The system of claim 1, wherein the housing is sized for single-hand grasp and provides splash resistance at least to IPX4, and the interchangeable head is configured to be detached and washed separately.

10. The system of claim 1, further comprising a temperature sensor within the housing configured to produce a temperature signal, wherein the controller responsive to the temperature signal exceeding a temperature threshold derates the commanded rotational speed or disables the drive to protect internal components and user safety.

11. The system of claim 1, further comprising a user control comprising a push-rotary knob providing ON/OFF enable and continuous speed selection, the push-rotary knob having tactile detents that do not impart vibration to the interchangeable head.

12. The system of claim 1, wherein a non-volatile memory stores calibration parameters comprising a mapping between motor current and inferred contact force, a commanded-speed-to-PWM-duty lookup adjusted for a speed-reduction train, and a magnet pull-force acceptance range for a magnetic quick-connect interface; and wherein the controller is coupled to the non-volatile memory and infers a contact-force condition from a motor-current signal via a current-sense circuit and the rotational-speed signal and, responsive to the contact-force condition exceeding a threshold, reduces PWM duty cycle to maintain a gentle-contact, non-vibratory slow-rotational stroking profile.

13. The system of claim 1, wherein the rotational drive and the interchangeable head are dynamically balanced to a runout limit at the head coupler of less than or equal to 0.25 millimeters during operation at a commanded rotational speed band.

14. A serving/manufacturing/hosting method comprising:
assembling a handheld tactile-stimulation device configured for on-device closed-loop operation, including a housing, a rechargeable power source, a direct-current motor with a speed-reduction train as a rotational drive, a head coupler, a microcontroller as a controller, and a non-volatile memory;
executing, on a provisioning fixture, a calibration process comprising:
measuring rotational speed under a plurality of known filament-tip loads and generating a commanded-speed-to-PWM-duty mapping for the speed-reduction train;
measuring motor current under the plurality of known filament-tip loads and generating a calibration curve for inferring contact force;
measuring a magnet pull force of a magnetic quick-connect interface and verifying a magnet pull force against an acceptance range; and
measuring runout at the head coupler and verifying the runout against a limit;
writing, to the non-volatile memory, firmware instructions and calibration parameters comprising the commanded-speed-to-PWM-duty mapping, a contact-force inference curve, and default preset parameters;
configuring the device such that, when later activated, the firmware instructions autonomously perform closed-loop PWM motor control via a PWM generator/driver without requiring external control; and
shipping the device.

15. The method of claim 14, further comprising verifying that the device maintains rotational speed within plus or minus 5 percent of a setpoint under a 20-gram filament-tip load and recording verification to the non-volatile memory; and wherein the device includes a magnetic quick-connect interface and an interchangeable head with flexible filaments.

16. The method of claim 14, further comprising programming presets including a lull preset, a drift preset, and a coast preset, each comprising a defined time-varying speed trajectory within a band of 30 to 100 revolutions per minute and including soft-start and soft-stop ramp profiles; and enabling a child-lock default state and an auto-off timer parameter in the non-volatile memory.

17. The method of claim 14, further comprising programming a PWM carrier frequency above 20 kilohertz to reduce audible switching noise during operation; and configuring the device to omit ultrasonic actuation, acoustic-pressure vibration, optical stimulation, and medicament delivery while operating.

18. The method of claim 14, further comprising recording, to the non-volatile memory, sanitation-cycle counters that increment upon detection of head removal and attachment events and gating preset execution until a sanitation acknowledgment input is received after a threshold number of attachment cycles.

19. A non-transitory computer-readable medium storing firmware instructions that, when executed by a microcontroller as a controller of a handheld tactile-stimulation device comprising a housing, a power source, a rotational drive, a head coupler, and a sensor configured to produce a rotational-speed signal, cause the microcontroller to regulate the rotational drive based on the rotational-speed signal.

20. The non-transitory computer-readable medium of claim 19, wherein the firmware instructions further cause the microcontroller to:
generate a pulse-width modulation (PWM) motor drive signal via a PWM generator/driver at a carrier frequency above an audible range;
execute a closed-loop control algorithm that adjusts a PWM duty cycle responsive to the rotational-speed signal to maintain a commanded rotational speed within a tolerance band under varying contact loads in a range of 30 to 100 revolutions per minute;
infer a contact-force condition from a motor-current signal via a current-sense circuit and the rotational-speed signal and, responsive to an inferred contact-force threshold being exceeded, reduce the PWM duty cycle to maintain a gentle-contact, non-vibratory slow-rotational stroking profile;
implement soft-start and soft-stop ramp profiles for transitions between commanded rotational speeds; and
terminate motor drive after a session duration elapses; and
wherein the device includes an interchangeable head including flexible filaments configured for gentle stroking contact against human skin.
